(19) United States
(12) Patent Application Publication
(10) Pub. No.: US 2026/0346897 A1
(43) Pub. Date: Nov. 5, 2026

(54) ADJUSTABLE STROLLERS

(71) Applicant: Baby Jogger, LLC, Atlanta, GA (US)

(72) Inventors: Jordi Dorca Pujol, Girona (ES); Daniel Emil Dziak, Atlanta, GA (US)

(21) Appl. No.: 19/100,076

(22) PCT Filed: Aug. 2, 2023
(86) PCT No.: PCT/US2023/029294

§ 371 Date: Jan. 30, 2025

Related U.S. Application Data
(60) Provisional application No. 63/394,681, filed on Aug. 3, 2022.

(51) Int. Cl. B62B 9/28; B62B 7/00; B62B 7/06; B62B 7/14

(52) U.S. Cl. CPC B62B 9/28; B62B 7/008; B62B 7/06; B62B 7/14

(57) ABSTRACT

An adjustable stroller assembly is provided. The adjustable stroller assembly may include a stroller frame having a pair of laterally opposed hubs, a pair of rear legs extending downwardly from the pair of laterally opposed hubs in a rearward direction, and a pair of front legs extending downwardly from the pair of laterally opposed hubs in a forward direction. The stroller assembly further may include a rear seat frame adjustably coupled to the pair of rear legs, and a front seat frame configured to be removably coupled to the pair of front legs. The rear seat frame may be configured to be adjusted relative to the pair of laterally opposed hubs between a first position and a second position that is relatively higher than the first position.

### CROSS-REFERENCE TO RELATED APPLICATION(S)

This application claims priority to and the benefit of U.S. Provisional Application No. 63/394,681, filed on Aug. 3, 2022, the disclosure of which is hereby incorporated herein by reference in its entirety.

### TECHNICAL FIELD

The present disclosure relates generally to strollers, and in particular, to adjustable strollers.

### BACKGROUND

Strollers may be used to seat children for travel or leisure. Some caregivers may have one child with them at one time, and more than one child with them at another time, and thus would require multiple strollers or a single stroller with multiple seats.

A need remains for strollers that can accommodate more than one child when necessary, while providing enough space between the children and privacy for each child when necessary

### BRIEF DESCRIPTION OF THE DRAWINGS

FIG. 1 illustrates an adjustable stroller assembly constructed in accordance with the principles of the present disclosure.

FIG. 2A illustrates the adjustable stroller assembly of FIG. 1 without a front seat.

FIGS. 2B to 2E illustrate various views of the stroller frame of the adjustable stroller assembly of FIG. 2A.

FIG. 3 illustrates a forward seat attachment of the adjustable stroller assembly of FIG. 1.

FIG. 4 illustrates the adjustable stroller assembly of FIG. 1 with the rear seat in an elevated position relative to the front seat in accordance with the principles of the present disclosure.

FIGS. 5A and 5B illustrate an alternative adjustable stroller assembly constructed in accordance with the principles of the present disclosure.

FIG. 6 illustrates another alternative adjustable stroller assembly constructed in accordance with the principles of the present disclosure.

FIG. 7 illustrates an alternative stroller frame constructed in accordance with the principles of the present disclosure.

FIG. 8 illustrates an alternative front set mount assembly constructed in accordance with the principles of the present disclosure.

FIG. 9 illustrates a foldable front seat frame of an adjustable stroller assembly in accordance with the principles of the present disclosure.

FIGS. 10A-10B illustrate a locking and unlocking mechanism for folding the front seat frame of FIG. 9 in accordance with the principles of the present disclosure.

FIG. 11A illustrates a perspective view of one side front seat frame of FIG. 9 in an unfolded configuration in accordance with the principles of the present disclosure.

FIG. 11B illustrates a bottom-up view of both sides of the front seat frame of FIG. 9 in a folded configuration in accordance with the principles of the present disclosure.

FIGS. 12A-12G illustrate alternative single seat arrangements on an adjustable stroller assembly in accordance with the principles of the present disclosure.

FIGS. 13A-13D illustrate alternative in line double seat arrangements on an adjustable stroller assembly in accordance with the principles of the present disclosure.

FIGS. 14A-14Q illustrate alternative staggered double seat arrangements on an adjustable stroller assembly in accordance with the principles of the present disclosure.

FIG. 15 illustrates an alternative adjustable stroller assembly constructed in accordance with the principles of the present disclosure.

FIG. 16 illustrates an alternative seat in accordance with the principles of the present disclosure.

FIG. 17 illustrates the seat of FIG. 16 including a canopy in accordance with the principles of the present disclosure.

FIG. 18A illustrates a side view of the seat of FIG. 16 in a folded configuration in accordance with the principles of the present disclosure.

FIG. 18B illustrates a perspective view of the seat of FIG. 16 in a folded configuration in accordance with the principles of the present disclosure.

FIG. 19A-19D illustrate components of a hub of the seat of FIG. 16 in accordance with the principles of the present disclosure.

FIG. 20 illustrates components of another hub of the seat of FIG. 16 in accordance with the principles of the present disclosure.

FIGS. 21A-21B illustrate an alternative seat in accordance with the principles of the present disclosure.

FIG. 22 illustrates an adjustable stroller assembly including the seat of FIG. 16 in accordance with the principles of the present disclosure.

FIGS. 23A-23C illustrate an adjustable stroller assembly in a folded configuration in accordance with the principles of the present disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

Some caregivers may have one child with them at one time, and more than one child with them at another time, and thus would require multiple strollers or a single stroller with multiple seats to accommodate both children at the same time. For example, a family may have more than one child, e.g., twins or two children born a few years apart. Moreover, strollers that are configured to accommodate more than one child still need to be manageable, such that they may be collapsed/expanded easily.

The present disclosure describes stroller assemblies that may be adjusted to accommodate more than one occupant, e.g., child. For example, an adjustable stroller assembly is provided. The adjustable stroller assembly may include a stroller frame having a pair of laterally opposed connection points, e.g., a pair of laterally opposed hubs, a plurality of wheels coupled to the stroller frame, a first seat frame adjustably coupled to the stroller frame, and a second seat frame configured to be removably coupled to the stroller frame. The first seat frame may be configured to be adjusted relative to the pair of laterally opposed connection points between a first position and a second position that is relatively higher than the first position.

In some embodiments, the first seat frame is slidably coupled to the rear frame assembly, such that the first seat frame is configured to slide along the rear frame assembly between the first position and the second position. Accordingly, the first seat frame may include one or more actuators configured to be actuated to permit sliding of the first seat frame between the first position and the second position. The stroller frame may include a rear frame assembly coupled to the pair of laterally opposed connection points. The rear frame assembly may include a pair of opposed rear bars extending from the pair of laterally opposed connection points. Each rear bar of the pair of opposed rear bars may define a respective channel, such that the first seat frame is slidably secured between and within the respective channels of the pair of opposed rear bars.

In addition, the stroller frame may include a front frame assembly coupled to the pair of laterally opposed connection points. The front frame assembly may include a seat frame mount, such that the second seat frame may be removably coupled to the seat frame mount. The stroller frame further may include an upper frame assembly coupled to the pair of laterally opposed connection points. For example, the upper frame assembly may include a pair of opposed upper bars extending from the pair of laterally opposed connection points, and a handle coupled between the pair of opposed upper bars. Moreover, the plurality of wheels may include at least two rear wheels and at least two front wheels. The pair of laterally opposed connection points may be offset from a geometric center between the at least two rear wheels and at least two front wheels in a direction toward the at least two rear wheels.

When the first seat frame is in the first position and the second seat frame is coupled to the stroller frame, the first seat frame and the second seat frame may be in a same plane. In addition, when the second seat frame is coupled to the stroller frame, the first seat frame and the second seat frame may face each other. At least one of the first seat frame or the second seat frame may be configured to support a stroller seat, a carrycot, and/or a car seat. The stroller assembly further may include at least one finishing material, e.g., a liner, a foam, a netting, a web, a fabric, or a padding, coupled to at least a portion of the adjustable stroller assembly. The first seat frame may be rotatably coupled to the pair of laterally opposed connection points, such that the first seat frame is configured to rotate about the pair of laterally opposed connection points between the first position and the second position. Accordingly, the first seat frame may include one or more actuators configured to be actuated to permit rotation of the first seat frame between the first position and the second position.

In accordance with another aspect of the present disclosure, another adjustable stroller assembly is provided. The adjustable stroller assembly may include a stroller frame having a pair of laterally opposed connection points, a rear seat frame configured to be slidably moveable along the stroller frame relative to the pair of laterally opposed connection points, and a front seat frame configured to be removably coupled to the stroller frame. The stroller frame may be configured to be actuated to slidably move the rear seat frame between a first position and a second position that is relatively higher than the first position.

In accordance with yet another aspect of the present disclosure, another adjustable stroller assembly is provided. The adjustable stroller assembly may include a stroller frame having a pair of laterally opposed connection points, a pair of rear legs extending downwardly from the pair of laterally opposed connection points in a rearward direction, and a pair of front legs extending downwardly from the pair of laterally opposed connection points in a forward direction. The stroller assembly further may include a rear seat frame adjustably coupled to the pair of rear legs, and a front seat frame configured to be removably coupled to the pair of front legs. The rear seat frame may be configured to be adjusted relative to the pair of laterally opposed connection points between a first position and a second position that is relatively higher than the first position.

In accordance with another aspect of the present disclosure, another adjustable stroller assembly is provided. The adjustable stroller assembly may include a stroller frame having a pair of laterally opposed connection points, a pair of rear legs extending downwardly from the pair of laterally opposed connection points in a rearward direction, a pair of upper bars extending upwardly from the pair of laterally opposed connection points in a rearward direction, a pair of rear support bars extending between the pair of rear legs and the pair of upper bars, and a pair of front legs extending downwardly from the pair of laterally opposed connection points in a forward direction. The adjustable stroller assembly further may include a rear seat frame adjustably coupled to the pair of rear support bars, such that the rear seat frame is configured to be adjusted relative to the pair of laterally opposed connection points between a first position and a second position that is relatively higher than the first position, and a front seat frame configured to be removably coupled to the pair of front legs.

In embodiments, the adjustable stroller assemblies described herein may provide the benefit of allowing a user to perform quick transitions between different stroller configurations (for example, transitioning between different combinations of seats provided at different orientations and heights on the stroller, adding and/or removing different stroller accessories, etc.). It should be noted that while a particular type of stroller configuration may be depicted herein (for example, a “baby jogger,” this is not intended to be limiting and the stroller may also be provided in any other suitable configuration, such as a pet stroller, a wagon, shopping basket and/or shopping cart, etc. Additionally, the stroller may be configured to be adjusted to these different types of stroller configurations.

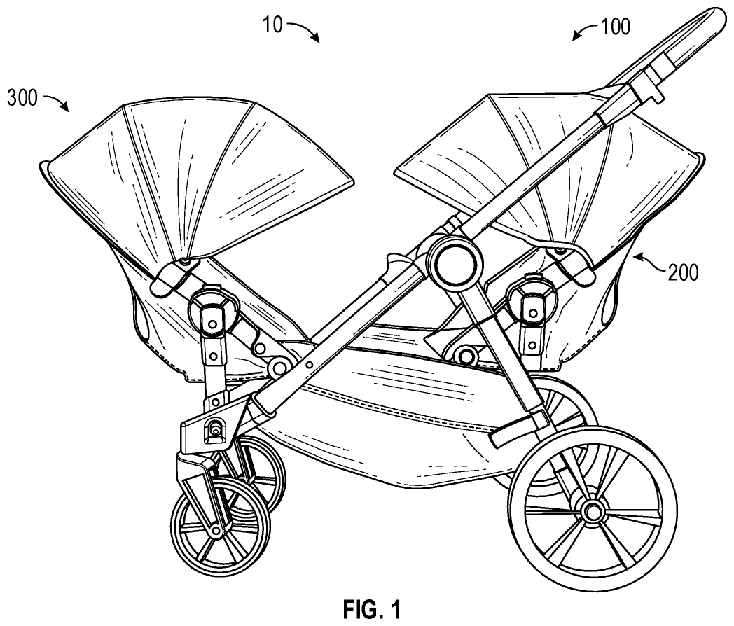

Referring now to FIG. 1, an adjustable stroller assembly is provided. Adjustable stroller assembly 10 may include stroller frame 100 having a first stroller seat, e.g., rear seat 200, and a second stroller seat, e.g., front seat 300, which may be removably coupled to stroller frame 100. Stroller frame 100 may be formed of one or materials, for example, a metal, an alloy, a plastic, a carbon-fiber, a composite material, or combinations thereof. Stroller frame 100 further may include one or more liners, e.g., a film, a fabric, a membrane, a shell, a netting, a web, a foam, a padding, or any other finishing or upholstery material or structure, or combinations thereof. Stroller assemblies according to the present disclosure may be relatively more flexible, light, and compact as compared to conventional strollers.

Rear seat 200 and/or or front seat 300 may include a frame assembly configured to accommodate an occupant, e.g., a child, in a laying down and/or seated position. For example, rear seat 200 and/or or front seat 300 may be covered with appropriate materials, e.g., liners, foams, netting, webs, fabrics, padding, or other finishing elements. Moreover, the respective frame assemblies may include a canopy frame configured to be covered with the appropriate material to form a canopy, as shown in FIG. 1. For example, the canopy frame may be retractable relative to the respective frame assembly to provide a covered and uncovered configuration.

Rear seat 200 is adjustably coupled to stroller frame 100, such that the position of rear seat 200 may be adjusted relative to stroller frame 100. For example, rear seat 200 may be locked in a first position relative to stroller frame 100, e.g., in a relatively lower position closer to the ground to provide a lower center of gravity of stroller assembly 10. In addition, rear seat 200 may be unlocked, moved to a second position relative to stroller frame 100, e.g., a in a relatively higher position farther from the ground than in the first position, and locked in the second position. Accordingly, stroller frame 100 may include one or more actuators, e.g., buttons, switches, levels, knobs, etc., configured to be actuated by a user to permit adjustment of rear seat 200, such that when the one or more actuators are not actuated, rear seat 200 remains in a locked configuration relative to stroller frame 100.

Moreover, front seat 300 may be removably coupled to stroller frame 100, such that when a second seat is not required for a second child, front seat 300 may be detached from stroller frame 100, and stored for safe keeping. When a second seat is required for a second child, front seat 300 may be attached to stroller frame 100, as described in further detail below, to accommodate the second child. Accordingly, when front seat 300 is attached to stroller frame 100, rear seat 200 may be locked in the first position such that rear seat 200 and front seat 300 are facing each other and in the same plane (e.g., same distance from the ground), so that if there is a child in each of rear seat 200 and front seat 300, the children may face each other and interact with each other. As shown in FIG. 1, front seat 300 may be spaced a predefined distance from rear seat 200, to thereby provide sufficient space between the children sitting in front seat 300 and rear seat 200. In some embodiments, front seat 300 may be oriented in the same direction as rear seat 200, e.g., both front seat 300 and rear seat 200 may be oriented such that the children sitting therein face the same direction as opposed to facing each other. Additionally, when one of the two children needs privacy, e.g., when one child is asleep or being fussy, rear seat 200 may be moved to and locked in the second position such that rear seat 200 is relatively higher than front seat 300, thereby keeping the children out of sight of each other, and providing privacy for both children.

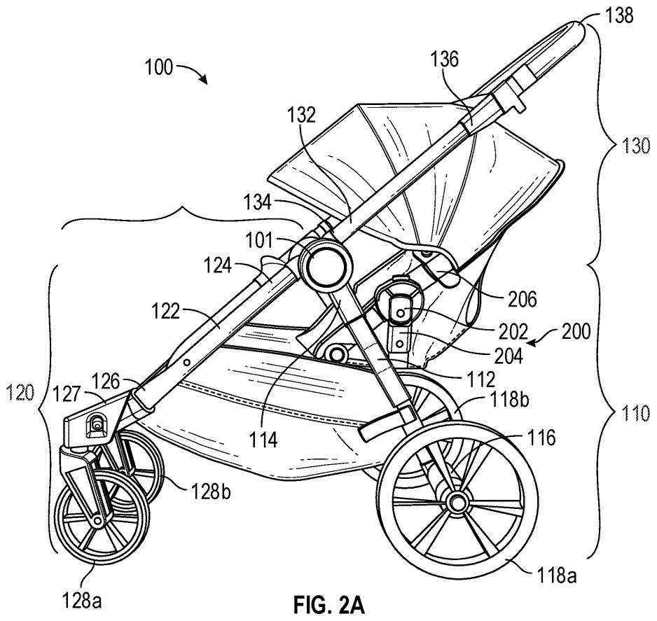

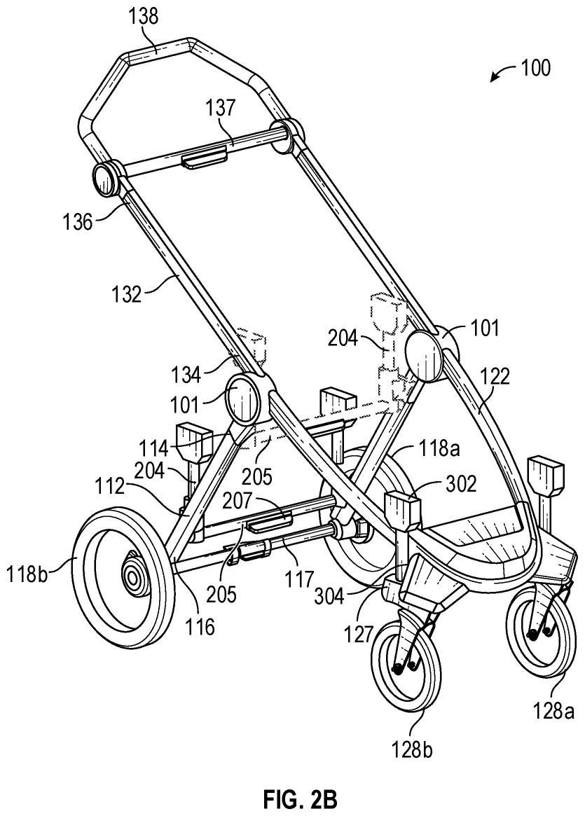

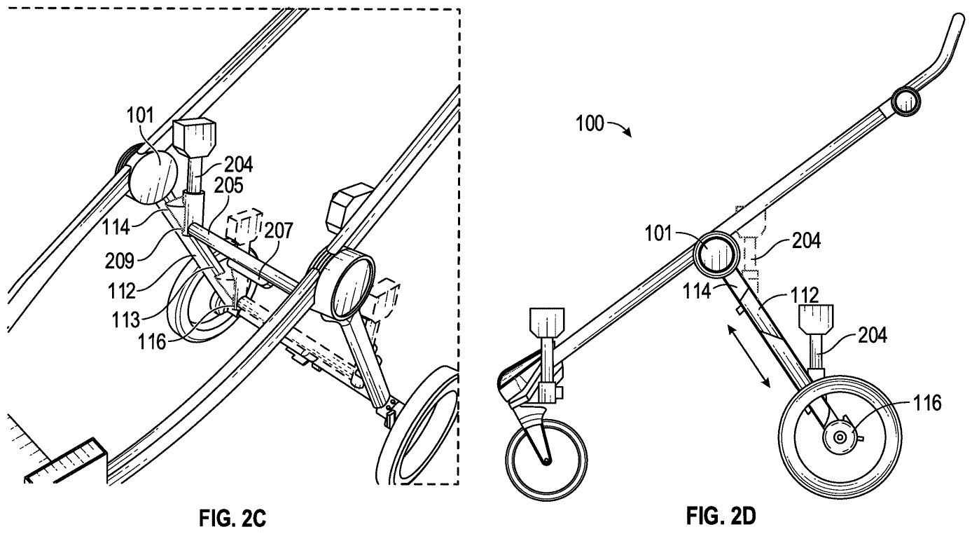

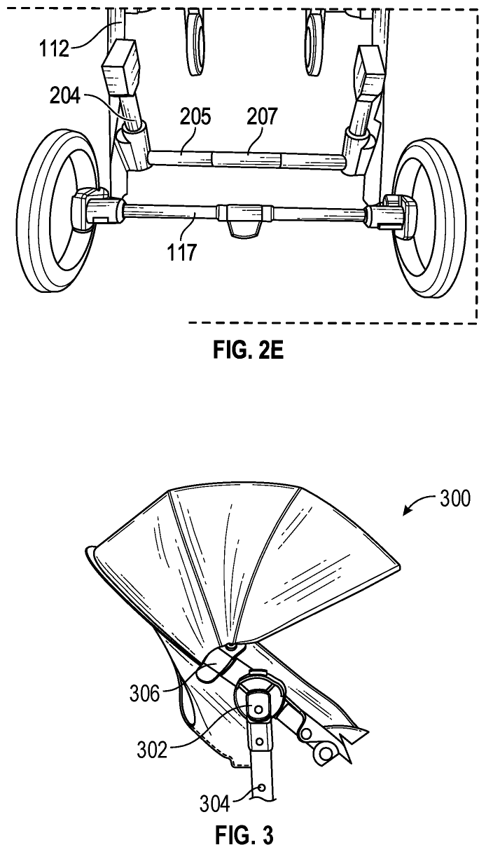

Referring now to FIGS. 2A to 2E, stroller frame 100 is described. Stroller frame 100 may include a pair of laterally opposed connection points, e.g., hubs 101, and rear frame assembly 110, front frame assembly 120, and upper frame assembly 130, all extending from and operatively coupled to hubs 101. Hubs 101 may be formed of one or more materials, for example, a metal, an alloy, a plastic, a carbon-fiber, a composite material, or combinations thereof. In some embodiments, stroller frame 100 is formed of an alloy, and hubs 101 are formed from plastic. Hubs 101 may be formed as left-right mirrored pairs, for example, with corresponding openings, edges, surfaces, or contours. As shown in FIGS. 2A to 2D, hubs 101 may be formed as substantially cylindrical shells, with one end of the respective cylinder being closed, and another end being open. For example, the closed ends of hubs 101 may face outward, while the open ends may face inward, e.g., to receive one or more components of stroller assembly 10. One or more portions or ends of stroller frame 100 may be received by corresponding windows, openings, slots, or tabs, defined in hubs 101. Hubs 101 may be rigid, but have some give or flexibility, to allow limited or defined relative movement between components of stroller assembly 10, for example, to permit folding and unfolding of stroller assembly 10.

Rear frame assembly 110 may include a pair of rear bars, e.g., rear legs 112, extending downwardly from hubs 101. For example, a left rear leg of pair of rear legs 112 may extend from a left hub of pair of hubs 101, and a right rear leg of pair of rear legs 112 may extend from a right hub of pair of hubs 101. Rear legs 112 may extend downwardly from hubs 101 at an angle relative to a vertical axis of stroller frame 100 in a rearward direction when stroller assembly 10 is in an operational stroller configuration as shown in FIG. 2A. Each rear leg 112 may include proximal end 114 configured to be operatively coupled to a respective hub 101, and distal end 116 configured to be operatively coupled to a respective rear wheel of stroller frame 100, e.g., rear wheel 118a or rear wheel 118b. For example, the left rear leg may be operatively coupled to left rear wheel 118a, and the right rear leg may be operatively coupled to right rear wheel 118b. The wheels described herein may be formed of any suitable material or combinations of materials. In addition, as shown in FIG. 2B, stroller frame 100 may include rear crossbar 117 coupled to and extending between at least one of the proximal ends 116 of pair of rear legs 112 or left rear wheel 118a and right rear wheel 118b, e.g., to provide stability to rear frame assembly 110. Rear crossbar 117 may include a foot pedal, which may be position in the center of rear crossbar 117.

As shown in FIG. 2C, each rear leg of pair of rear legs 112 may define a channel, parallel rails, or slots therein, e.g., channel 113. For example, the respective channels may be on the inward facing side of rear legs 112, such that they are not readily visible from the exterior of sides of stroller frame 100. Channels 113 may be sized and shaped to receive a corresponding pin, e.g., pin 209, of a corresponding connection link 204 of rear seat 200, such that rear seat 200 may be slidably moveable along rear legs 112 within the respective channels, e.g., in the direction of the arrow as shown in FIG. 2D.

As shown in FIG. 2A, rear seat 200 may include rear seat frame 202, which includes a pair of connection links 204 configured to be slidably coupled to pair of rear legs 112. FIGS. 2B to 2E only illustrate connection links 204 of rear seat frame 202 for brevity.

As described above, each connection link 204 may include a protrusion, e.g., pins 209, sized and shaped to securely engage with a respective channel of rear legs 112. As shown in FIGS. 2B and 2C, rear seat frame 202 further may include crossbar 205 extending between the pair of connection links 204. Accordingly, pins 209 may be disposed within crossbar 205, and are operatively coupled to actuator 207 disposed on crossbar 205. For example, when actuator 207 is not actuated, pins 209 may engage with channels 113 to thereby lock the position of rear seat frame 202 relative to rear legs 112. Accordingly, rear legs 112 may include a locking mechanism, e.g., detents, tabs, or locks, configured to lock pins 209 of rear seat 200 relative to rear legs 112 within respective channels 113. Moreover, when actuator 207 is actuated, pins 209 may be retracted, e.g., within crossbar 205, such that pins 209 disengages within channels 113 and rear seat frame 202 may be moved relative to rear legs 212 within channel 113. For example, when pins 209 are disengaged within channels 113, pins 209 may still be disposed within channels 113 in an unlocked state such that movement of rear seat 202 along rear legs 212 is guided by pins 209 within channels 113. The locking mechanism may lock rear seat 200 in a first position at a lower end of the respective channels, and in a second position at an upper end of the respective channels, such that rear seat 200 is relatively higher in the second position than in the first position.

In some embodiments, the locking mechanism may lock rear seat 200 in incremental positions along the length of the respective channels between the first and second positions. As described above, stroller frame 100 may include one or more actuators, e.g., actuator 207, buttons, switches, levels, knobs, etc., configured to be actuated by a user to unlock the locking mechanism, such that rear seat 200 may be adjusted relative to rear legs 112. In addition, when the one or more actuators are no longer actuated, e.g., released, the locking mechanism will lock rear seat 200 in position relative to rear legs 112. For example, actuation of actuator 207 may cause the locking mechanism to unlock with pins 209, and release of actuator 207 may cause the locking mechanism to relock with pins 209.

As shown in FIG. 2A, rear seat frame 202 may include canopy frame 206 configured to be coupled to a material to form a canopy of rear seat 200. Canopy frame 206 may include a plurality of retractable canopy links, such that canopy frame 206 may be transitioned/folded between an uncovered configuration and a covered configuration as shown in FIG. 2A.

Front frame assembly 120 may include a pair of front bars, e.g., front legs 122, extending downwardly from hubs 101. For example, a left front leg of pair of front legs 122 may extend from a left hub of pair of hubs 101, and a right front leg of pair of front legs 122 may extend from a right hub of pair of hubs 101. Front legs 122 may extend downwardly from hubs 101 at an angle relative to a vertical axis of stroller frame 100 in a forward direction when stroller assembly 10 is in an operational configuration as shown in FIG. 2A. Each front leg 122 may include proximal end 124 configured to be operatively coupled to a respective hub 101, and distal end 126 configured to be operatively coupled to a respective front wheel of stroller frame 100, e.g., front wheel 128a or front wheel 128b. For example, the left front leg may be operatively coupled to left front wheel 128a, and the right front leg may be operatively coupled to right front wheel 128b. The wheels described herein may be formed of any suitable material or combinations of materials.

In some embodiments, stroller frame 100 may include a front crossbar coupled to and extending between at least one of the proximal ends 126 of pair of front legs 122 or left front wheel 128a and right front wheel 128b, e.g., to provide stability to front frame assembly 120. Moreover, each front leg of pair of front legs 122 may include connection mount 127 configured to be removably coupled to a corresponding pair of connection links of front seat 300, as described in further detail below. As shown in FIG. 2A, each hub of pair of laterally opposed hubs 101 may be offset from a geometric center of stroller frame 100 between front wheels 128a, 128b and rear wheels 118a, 118b in a direction toward rear wheels 118a, 118b. For example, hubs 101 may be closer to rear wheels 118a, 118b than to front wheels 128a, 128b. Front frame assembly 120 may facilitate distributing load or weight of a child along stroller frame 100. Front frame assembly 120 also may facilitate folding of stroller assembly 10, e.g., for storage or transport. For example, one or both of front frame assembly 120 and rear frame assembly 110 may be configured to rotate about hubs 101 toward each other to ultimately fold stroller assembly 10, and away from each other to unfold stroller assembly 10.

Upper frame assembly 130 may include a pair of upper bars 132 extending upwardly from hubs 101. For example, a left upper bar of pair of upper bars 132 may extend from a left hub of pair of hubs 101, and a right upper bar of pair of upper bars 132 may extend from a right hub of pair of hubs 101. Upper bars 132 may extend upwardly from hubs 101 at an angle relative to a vertical axis of stroller frame 100 in a rearward direction when stroller assembly 10 is in an operational stroller configuration as shown in FIG. 2A. Each upper bar 132 may include proximal end 134 configured to be operatively coupled to a respective hub 101, and distal end 136 configured to be coupled to handle 138.

As shown in FIG. 2B, handle 138 may extend between distal ends 136 of pair of upper bars 132. Handle 138 may have a U-shape, and/or may be adjustable or foldable, and may provide extra protection for a child's body or head, for example, when rear seat 200 is in the first position. A user may hold or grip a portion of handle 138, for example, to direct the motion of stroller assembly 10 in the operational stroller configuration. Upper frame assembly 130 further may act as a truss to redistribute load or weight, and further support lower frame assembly 110, and stroller frame 100 as a whole. As shown in FIG. 2B, upper frame assembly 130 may include crossbar 137 extending between distal ends 136 of pair of upper bars 132 to provide lateral support and stability to upper assembly 130, and to the stroller frame 12 as a whole. Handle 138 may be rotatably coupled to crossbar 137, e.g., via an actuator position on crossbar 137.

Stroller frame 100 may be foldable, for example, by relative rotation about hubs 101 of portions of stroller frame 100. For example, stroller assembly 10 may be folded for storage in a storage configuration. Accordingly, stroller frame 100 may include a fold lock mechanism coupled to upper frame assembly 130. The fold lock mechanism may resist a folding of stroller frame 100 about pair of laterally opposed hubs 101. The fold lock mechanism may include an actuator, e.g., a button, configured to temporarily defeat the resistance to folding. For example, a cable, a chain, a pin, or some other mechanism that blocks folding of one or more portions of stroller frame 100 about hubs 101 may be mechanically coupled to the actuator, such that actuating the actuator, e.g., pressing the button, may disengage the cable or pin, allowing folding of stroller frame 100 to proceed.

Referring now to FIG. 3, a removable front seat attachment is provided. As shown in FIG. 3, front seat 300 may include front seat frame 302, which includes a pair of connection links 304 configured to be removeably coupled to pair of connection mounts 127. For example, connection links 304 may be coupled to connection mounts 127 via a screw attachment, a friction attachment, a snap-fit attachment, a clamp attachment, etc. Moreover, front seat frame 302 may include canopy frame 306 configured to be coupled to a material to form a canopy of front seat 300. Canopy frame 306 may include a plurality of retractable canopy links, such that canopy frame 306 may be transitioned/folded between an uncovered configuration and a covered configuration as shown in FIG. 3. Accordingly, front seat 300 may be removed when stroller assembly 10 only needs to accommodate a single child, and may be reattached to stroller frame 100 when stroller assembly 10 is used to accommodate a second child in addition to the first child.

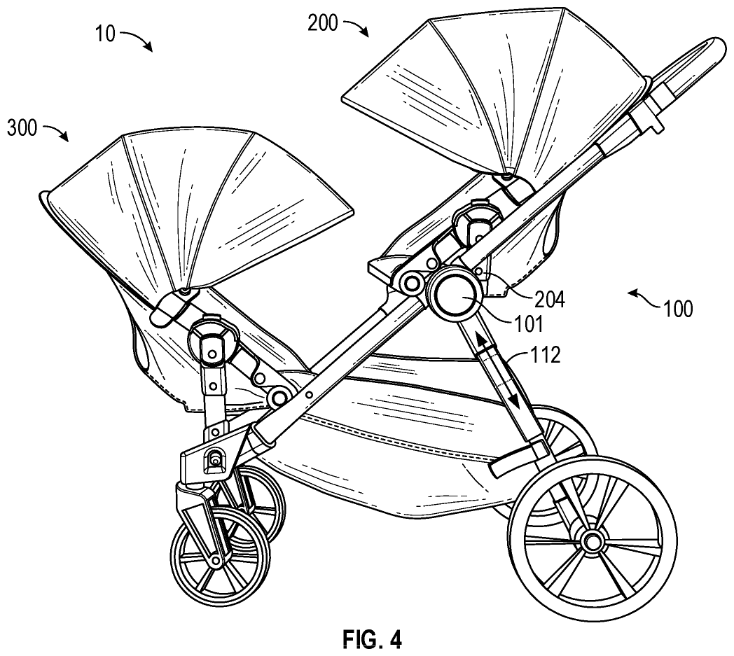

Referring now to FIG. 4, adjustment of rear seat 200 of stroller assembly 10 is described. As described above, when one of the two children sitting in rear seat 200 or front seat 300 needs privacy, e.g., when one child is asleep or being fussy, rear seat 200 may be moved to and locked in the second position such that rear seat 200 is relatively higher than front seat 300, as shown in FIG. 4. For example, the locking mechanism of stroller frame 100 may be unlocked, e.g., via an actuator, and rear seat 200 may be moved to the second position by sliding connection links 204 of rear seat 200 along the respective channels of rear legs 112 in an upward direction, and locked in the second position via the locking mechanism. Accordingly, the children may be kept out of sight of each other, thereby providing privacy for both children. Moreover, the locking mechanism of stroller frame 100 may be unlocked, e.g., via an actuator, and rear seat 200 may be moved back to the first position by sliding connection links 204 of rear seat 200 along the respective channels of rear legs 112 in a downward direction, and locked in the first position via the locking mechanism. In some embodiment, rear seat 200 may not be slidable, and instead, may be fixedly secured by removing and remounting at each distinct position along rear legs 112.

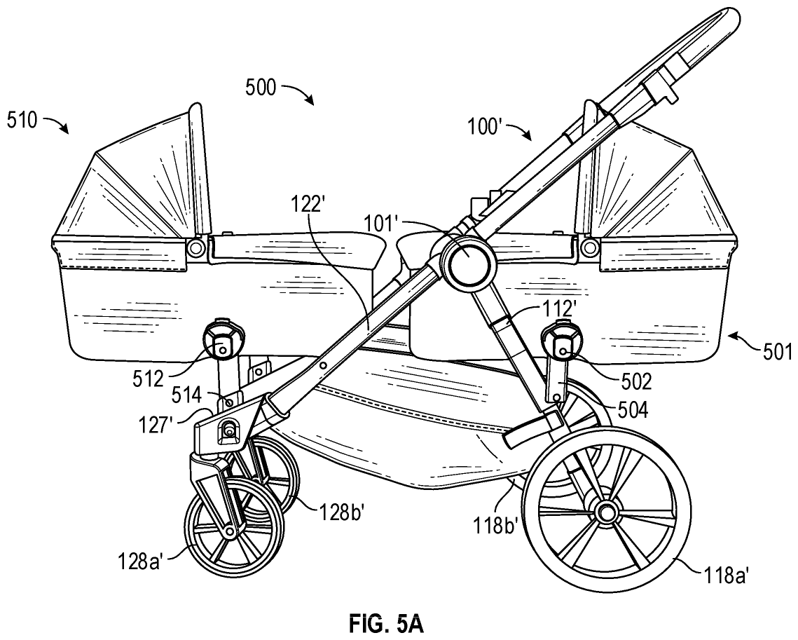

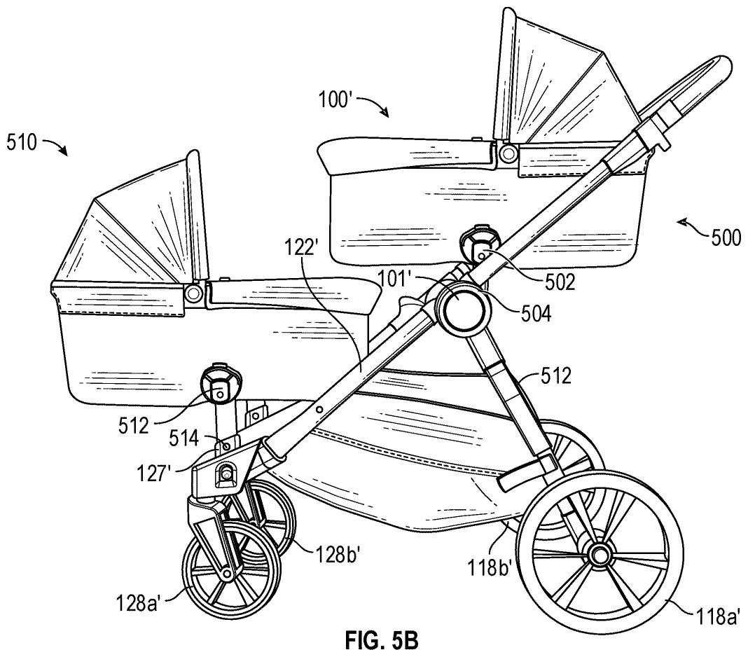

Referring now to FIGS. 5A and 5B, an adjustable carrycot stroller assembly is provided. Adjustable carrycot stroller assembly 500 may include stroller frame 100′ having a first stroller seat, e.g., rear carrycot 501, and a second stroller seat, e.g., front carrycot 510, which may be removably coupled to stroller frame 100′. Rear carry cot frame 502 and/or or front carrycot frame 512 may be covered with appropriate materials, e.g., liners, foams, netting, webs, fabrics, padding, or other finishing elements, to form a carrycot, as shown in FIGS. 5A and 5B. Moreover, the carrycot frames may include a canopy portion that may be retractable relative to the respective carrycot frame assembly to provide a covered and uncovered configuration.

Stroller frame 100′ may be constructed similar to stroller frame 100 with similar components having liked-primed reference numerals. Stroller frame 100′ differs from stroller frame 100 in that the rear frame assembly of stroller frame 100′ is configured to be slidably coupled to rear carrycot 501, and the front frame assembly of stroller frame 100′ is configured to be removably coupled to front carrycot 510. For example, rear carrycot 500 includes rear carrycot frame 502 having pair of connection links 504, which may be slidably engaged within a pair of corresponding channels extending within rear legs 112′, such that rear carrycot 500 may be slidably moved along rear legs 112′ between a first position, as shown in FIG. 5A, and a second position relatively higher than the first position, as shown in FIG. 5B. Connection links 504 may be constructed similar to connection links 204 of rear seat frame 202. Moreover, front carrycot 510 includes front carrycot frame 512 having pair of connection links 514, which are configured to be removably coupled to connection mounts 127′ of stroller from 100′.

As will be understood by a person having ordinary skill in the art, various seating frames may be used with the stroller assemblies described herein. For example, in addition to the stroller seats and carrycots described above, a rear car seat may be slidably coupled to the stroller frame, and a front car seat may be removably coupled to the stroller frame. Moreover, in some embodiments, the rear seat may be removably attached to the stroller frame. In addition, the front seat may be slidably moveable along the stroller frame relative to the laterally opposed hubs.

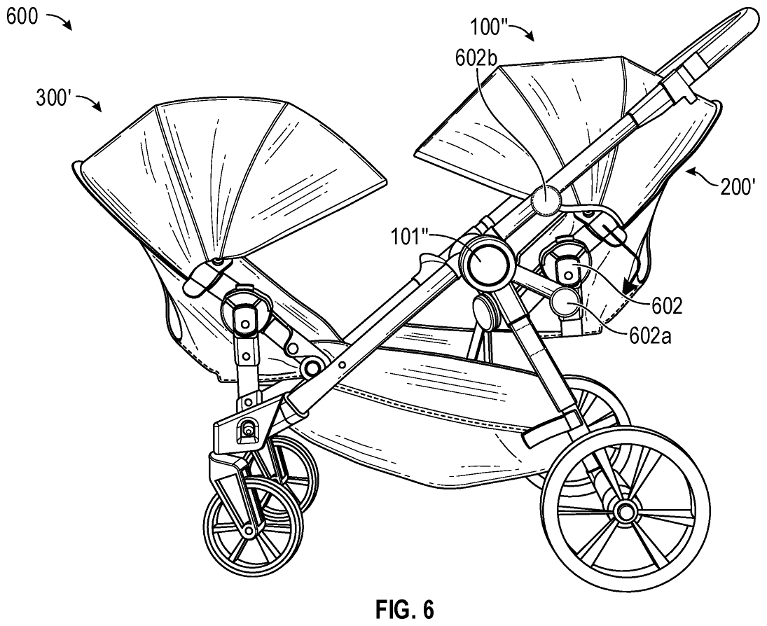

Referring now to FIG. 6, an alternative stroller assembly is provided. Stroller assembly 600 may include stroller frame 100″ having a first stroller seat, e.g., rear seat 200″, and a second stroller seat, e.g., front seat 300″, which may be removably coupled to stroller frame 100″. Stroller frame 100″ may be constructed similar to stroller frame 100 with similar components having like double-prime reference numerals. Moreover, rear seat 200′ and front seat 300′ may be constructed similar to rear seat 200 and front seat 300, respectively, with similar components having like-prime reference numerals.

Stroller frame 100″ and rear seat 200′ differ from stroller frame 100 and rear seat 200 in that rear seat 200′ is rotatably coupled to pair of laterally opposed hubs 101″ of stroller frame 100″, to thereby permit adjustment of rear seat 200′ relative to hubs 101″.

For example, rear seat 200′ may include a rear seat frame having pair of rotatable connection links 602 rotatably coupled to hubs 101″, such that rear seat 200′ may be rotatably moved between first position 602a and second position 602b relatively higher than first position 602a. In addition, stroller frame 100″ may include a locking mechanism configured to lock rear seat 200′ in first position 602a and in second position 602b relative to stroller frame 100″. Moreover, stroller frame 100″ may include one or more actuators configured to be actuated to permit transition of rear seat 200′ between first position 602a and second position 602b.

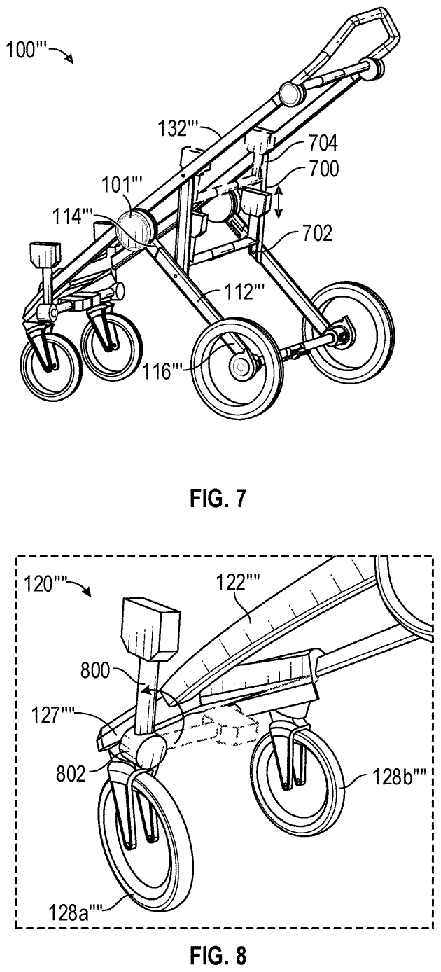

Referring now to FIG. 7, an alternative stroller frame is provided. Stroller frame 100″ may be constructed similar to stroller frame 100 with similar components having like triple-prime reference numerals. Stroller frame 100″′ differs from stroller frame 100 in such stroller frame 100″′ includes a pair of rear seat support bars 700. As shown in FIG. 7, upper bars 132″′ may extend upwardly from the pair of laterally opposed connection points 101′″ and rear legs 112″ may extend downwardly from the pair of laterally opposed connection points 101″, such that support bars 700 may extend from upper bars 132′″ toward rear legs 112″. For example, lower end 702 of support bar 700 may be coupled to rear legs 112′″, and upper end 704 of support bar 700 may be coupled to upper bars 132″. Moreover, support bars 700 may have channels therein, constructed similar to channels 113 of stroller frame 100, configured to slidably engage with corresponding pins of the rear seat frame. Thus, rear legs 112′″ may not have channels disposed therein. Accordingly, the rear seat frame may be moveable along the channels of support bar 700 between a first position towards lower end 702 and a second position towards upper end 704 that is relatively higher than the first position.

Referring now to FIG. 8, an alternative front seat mounting assembly is provided. Front frame assembly 120″″ may be constructed similar to front frame assembly 120 with similar components having like quadruple-prime reference numerals. Front frame assembly 120″″ differs from front frame assembly 120 in that mount 127″″ is pivotally coupled to mounting assembly 800, which is configured to be coupled to the upper seat frame. Accordingly, the upper seat frame may not include connection links 304, but instead may be removably coupled to mounting assembly 800. As shown in FIG. 8, mounting assembly 800 may be pivotally coupled to mount 127″″ via pivot point 802, such that mounting assembly 800 may be rotated about pivot point 802 between a mount-ready position and a storage position (denoted by the dashed lines) where mounting assembly 800 is directed inward to reduce the profile of front frame assembly 120″″, e.g., to avoid inadvertent collisions between mounting assembly 800 and foreign objects when mounting assembly 800 is in the mount-ready position.

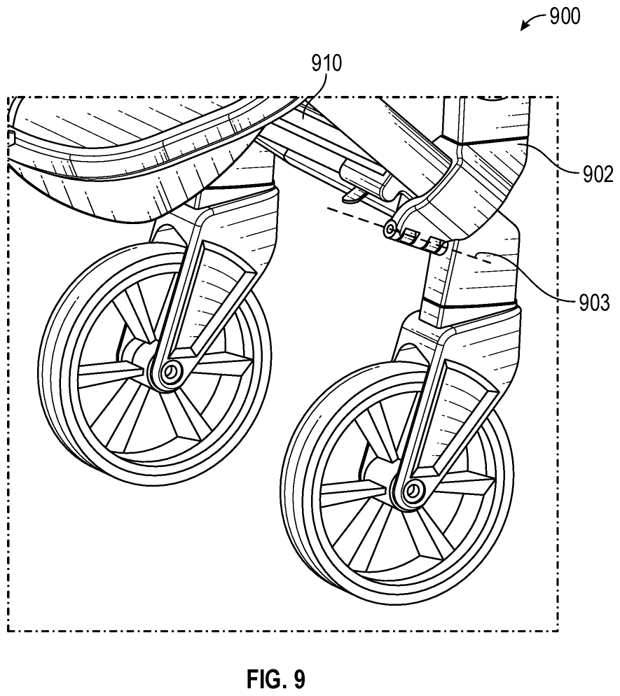

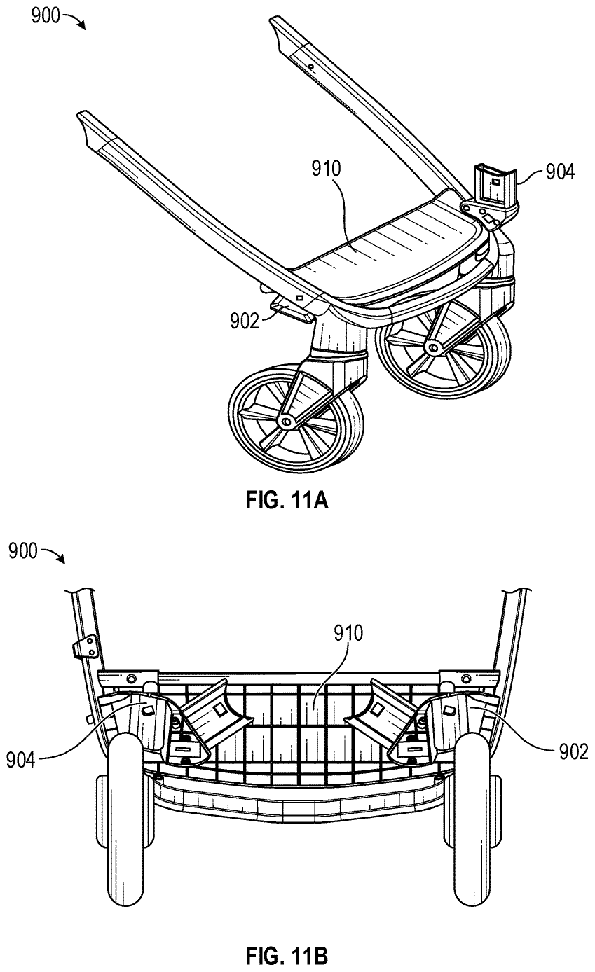

FIG. 9 illustrates a foldable front seat frame 900 (for example, front seat frame 302 and/or any other front seat frame described herein) of an adjustable stroller assembly (for example, any stroller assembly described herein, such as stroller assembly 10, 500, 600, etc.). The front seat frame 900 may include a pair of laterally opposed connection links, including first connection link 902 and second connection link 904 (the second connection link 904 is not shown in FIG. 9 but is shown in at least FIGS. 11A-11B) that may be rotated inwards and stored under the footrest 910 in a folded configuration (also shown in FIG. 11B). As shown in FIG. 9, the rotation of the first front seat frame 902 may be performed about an axis 903. Although not shown in FIG. 9, the second connection link 904 may be rotated for storage underneath the footrest 910 in a similar manner. The front seat frame 900 being foldable provides for a more compact configuration for the adjustable stroller assembly for storage or transport (for example, when a seat is not inserted into the front seat frame).

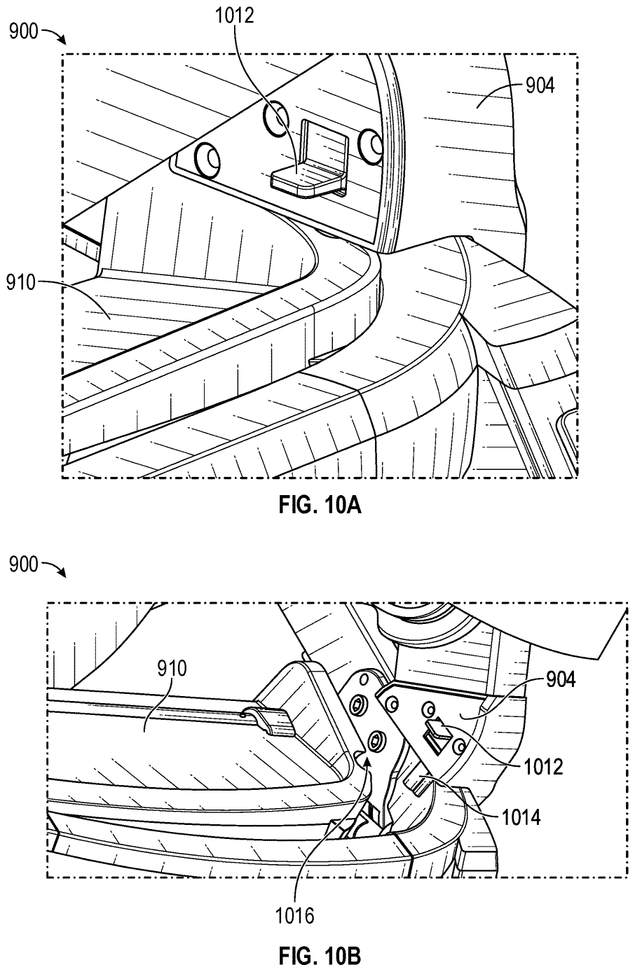

FIGS. 10A-10B illustrate a locking and unlocking mechanism for folding and unfolding the front seat frame 900 of FIG. 9 (the figures show a close-up view of the second connection link 904). As shown in FIGS. 10A-10B, the locking and unlocking mechanism includes a tab 1012 that is coupled to a pin 1014 within the second connection link 904. In embodiments, the tab 1012 may be accessible to a user through the interior of the second connection link 904 (and/or the first connection link 902). However, the locking and unlocking mechanism may also be provided on the exterior of the second connection link 904 as well (for example, the tab 1012 may be accessible on the exterior of the second connection link 904, rather than the interior as shown in FIGS. 10A-10B) and/or any other location.

When the front seat frame 900 is locked in an unfolded position, the tab 1012 is in a first position (as shown in FIG. 10A) and the pin 1016 is located within an aperture 1016 in the footrest 910. When the pin 1014 is located in the aperture 1016, the pin 1014 prevents rotation of the second connection link 904 to the folded position. Thus, the front seat frame 900 remains locked in the unfolded position.

When it is desired to fold the second connection link 904 behind the footrest 910 for storage, the tab 1012 may be pushed upwards by the user to a second position (shown in FIG. 10B). This, in turn, moves the pin 1014 upwards and out of the aperture 1016. In this second position, the pin 1014 is no longer preventing the rotation of the second connection link 904 and the second connection link 904 may then be rotated about the axis 903 and folded underneath the footrest 910.

In embodiments, the locking and unlocking mechanism may also be spring-loaded, such that when the second connection link 904 is rotated back into an unfolded position, the pin 1014 may return to the inside the aperture 1016 and the tab 1012 may return to the first position, locking the second connection link 904 in the unfolded position. That is, when the user releases the tab 1012 after pushing the tab 1012, the tab 1012 may return to the first position. Although not shown in the figure, a similar locking and unlocking mechanism may be used for the first connection link 902 as well.

FIGS. 11A-11B illustrate a comparison between the front seat frame 900 in an unfolded configuration (FIG. 11A) and a folded configuration (FIG. 11B). Particularly, FIG. 11A illustrates a perspective view of the front seat frame 900 with one side front seat frame 900 of being in an unfolded configuration (e.g., the second connection link 904), and one side of the front seat frame 900 being in a folded configuration (e.g., the first connection link 902). FIG. 11B illustrates a bottom-up view of both sides of the front seat frame of FIG. 9 in the folded configuration such that both the first connection link 902 and second connection link 904 are stowed underneath the footrest 910 for storage. As shown in FIG. 11B, the first connection link 902 and the second connection link 904 are rotated inwards and underneath the footrest 910 in the folded configuration. When it is desired to return the first connection link 902 and the second connection link 904 back to the unfolded configuration (for example, to unfold the stroller assembly to provide a seat within the first connection link 902 and the second connection link 904), the first connection link 902 and the second connection link 904 may be rotated outwards and upwards. When the first connection link 902 and the second connection link 904 are fully rotated to the unfolded position, the pin 1014 may slidably insert into the aperature 1016 to lock the second connection link 904 in the unfolded position (in some instances, a similar mechanism may apply to the first connection link 902 as well.

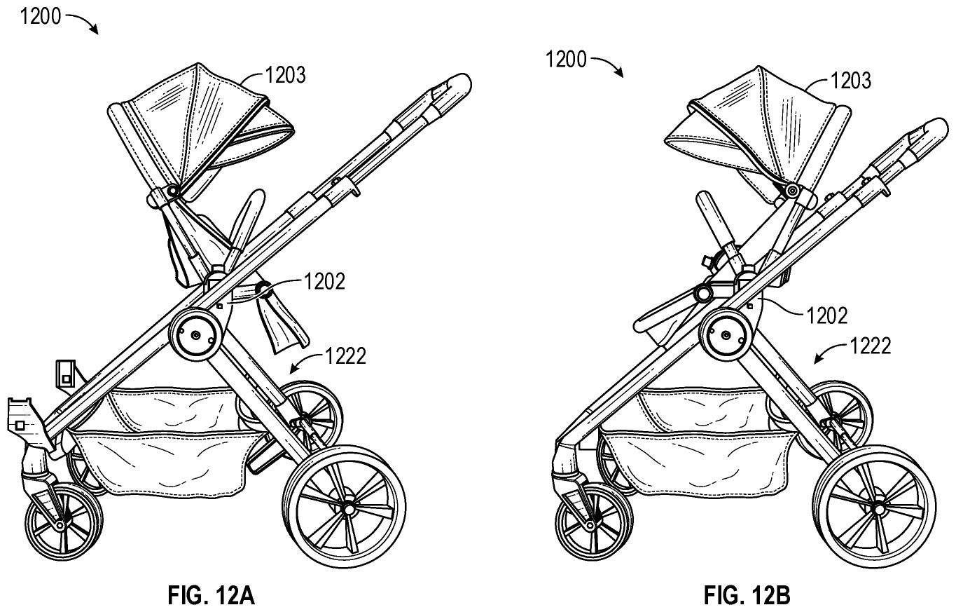

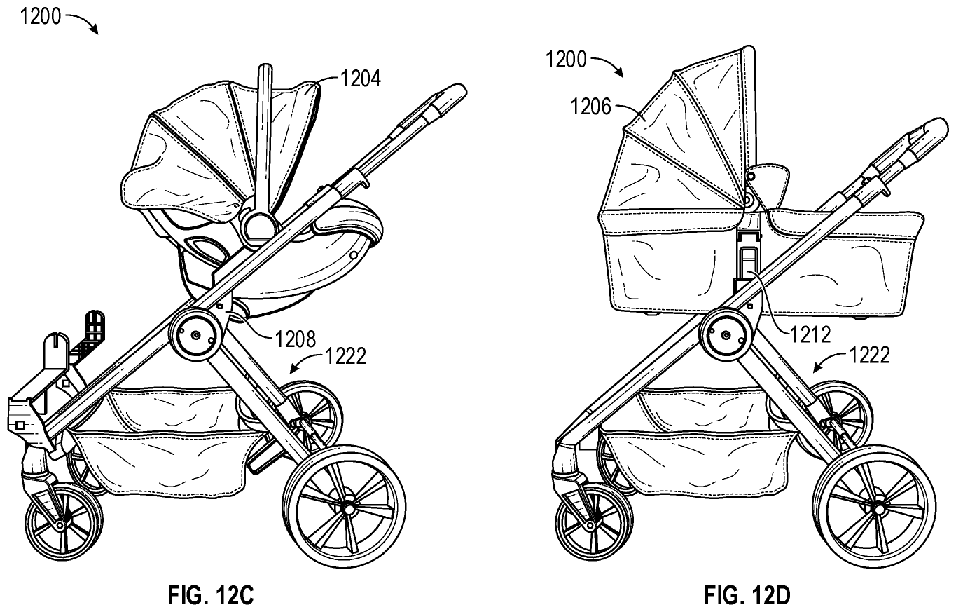

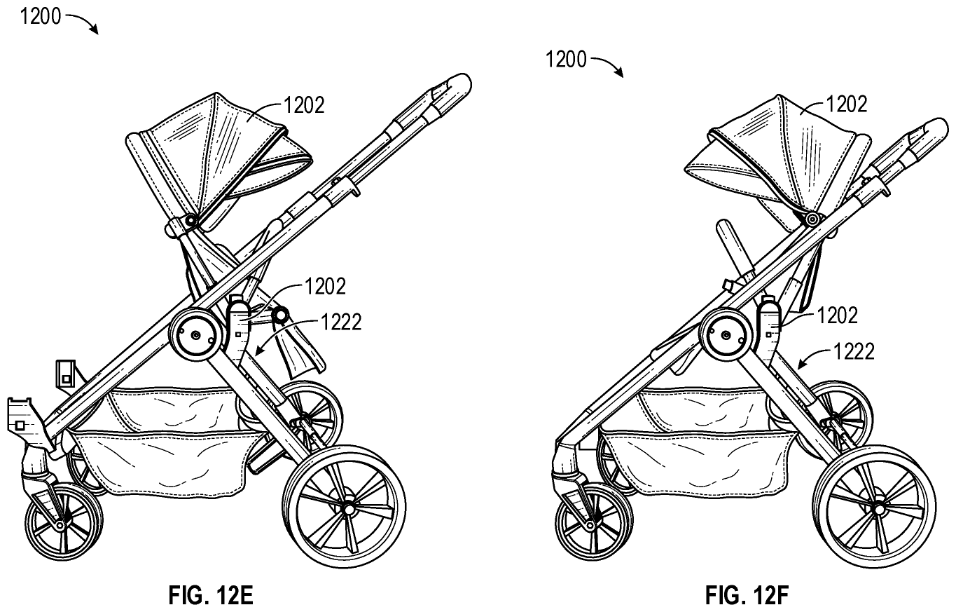

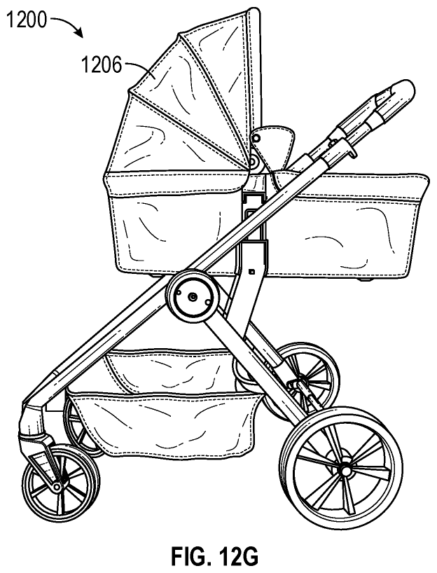

FIGS. 12A-12G illustrate alternative single seat arrangements on an adjustable stroller assembly 1200 in accordance with the principles of the present disclosure.

FIG. 12A shows a first configuration in which a seat frame 1202 (such as seat frame 202 or any other seat frame described herein) of a first type of seat 1203 is inserted into respective channels of rear legs 1222 of the adjustable stroller assembly 1200. In FIG. 12A, the first type of seat 1203 is provided at a first height along the respective channels. The first type of seat 1203 is also provided in a first orientation (for example, rearward-facing). FIG. 12B shows a second configuration in which the first type of seat 1202 is provided in a different orientation (for example, forward-facing).

FIG. 12C shows a third configuration in which a seat frame 1208 (such as seat frame 202 or any other seat frame described herein) of a second type of seat 1204 is inserted into respective channels of rear legs 1222 of the adjustable stroller assembly 1200. In FIG. 12C, the second type of seat 1204 is provided at a first height along the respective channels. The second type of seat 1204 is also provided in a first orientation (for example, rearward-facing). FIG. 12D shows a fourth configuration in which a third type of seat 1206 is also provided at the same height by inserting seat frame 1212 into respective channel of the rear legs 1222 of the adjustable stroller assembly 1200. The third type of seat 1206 is also provided in the first orientation (for example, rearward-facing).

FIG. 12E shows a fifth configuration in which the seat frame 1202 of the first type of seat 1203 is inserted into respective channels of rear legs 1222 of the adjustable stroller assembly 1200. In FIG. 12E, the first type of seat 1203 is provided at a different height along the respective channels than the first type of seat 1203 shown in FIG. 12A.

The first type of seat 1203 is also provided in the first orientation (for example, rearward-facing). FIG. 12F shows a sixth configuration in which the first type of seat 1202 is provided in a different orientation (for example, forward-facing) and at a different height than the first type of seat 1203 shown in FIG. 12B.

FIG. 12G shows a seventh configuration in which the third type of seat 1206 is provided at a different height than the third type of seat 1206 shown in FIG. The third type of seat 1206 shown in FIG. 12G is also provided in the first orientation (for example, rearward-facing).

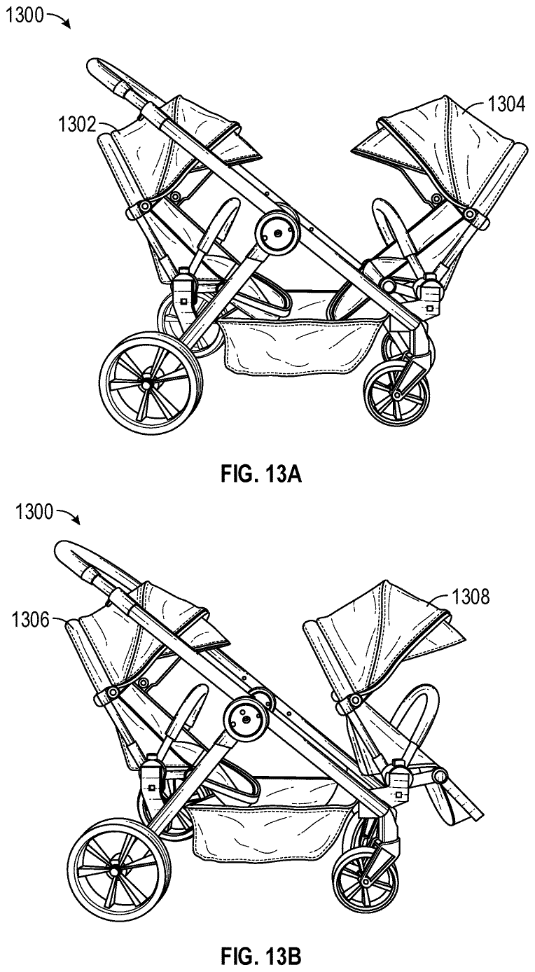

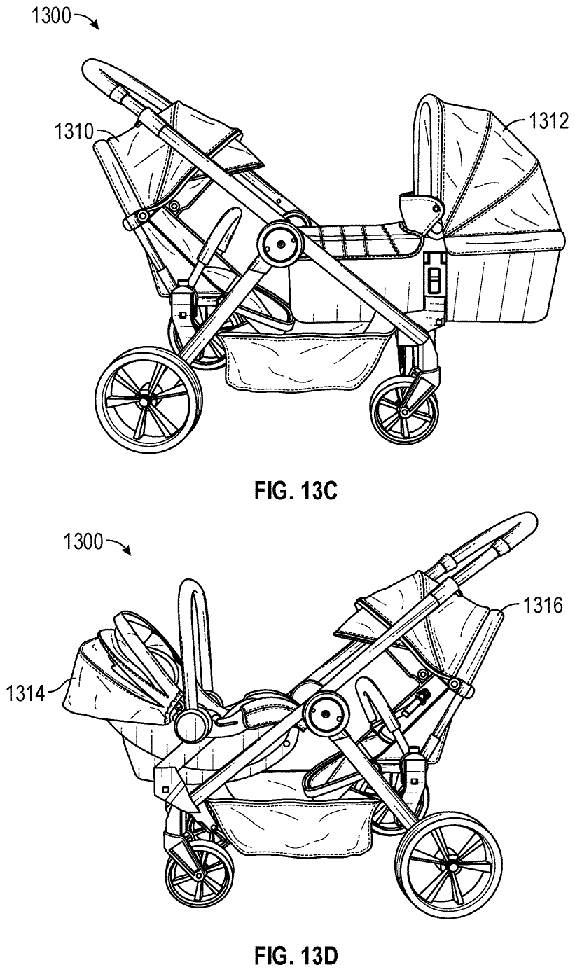

FIGS. 13A-13D illustrate alternative in line double seat arrangements on an adjustable stroller assembly 1300.

FIG. 13A shows a first seat 1302 and a second seat 1304 (which may both be a first type of seat) that are provided at the same height but in different orientations. For example, the first seat 1302 is shown as facing a first orientation (e.g., forward-facing) and the second seat 1304 is shown as facing a second orientation (e.g., rearward-facing). Thus, the first seat 1302 and the second seat 1304 are at the same height and facing each other. FIG. 13B shows a first seat 1306 and a second seat 1308 (which may both be the first type of seat) that are provided at the same height and in the same orientation. That is, the first seat 1306 and second seat 1308 are both at the same height and both forward-facing.

FIG. 13C shows a first seat 1310 and a second seat 1312 that are provided at the same height but in different orientations. The first seat 1310 may be the first type of seat and the second seat 1312 may be a second type of seat. For example, the first seat 1310 is shown as facing a first orientation (e.g., forward-facing) and the second seat 1312 is shown as facing the second orientation (e.g., rearward-facing). Thus, the first seat 1310 and the second seat 1312 are at the same height and facing different directions. FIG. 13D also shows a first seat 1314 and a second seat 1316 that are provided at the same height and in different orientations. The first seat 1314 may be a third type of seat and the second seat 1316 may be the first type of seat. For example, the first seat 1314 is shown as facing a second orientation (e.g., rearward-facing) and the second seat 1316 is shown as facing the first orientation (e.g., forward-facing). That is, the first seat 1314 and second seat 1316 are both at the same height and are facing one another.

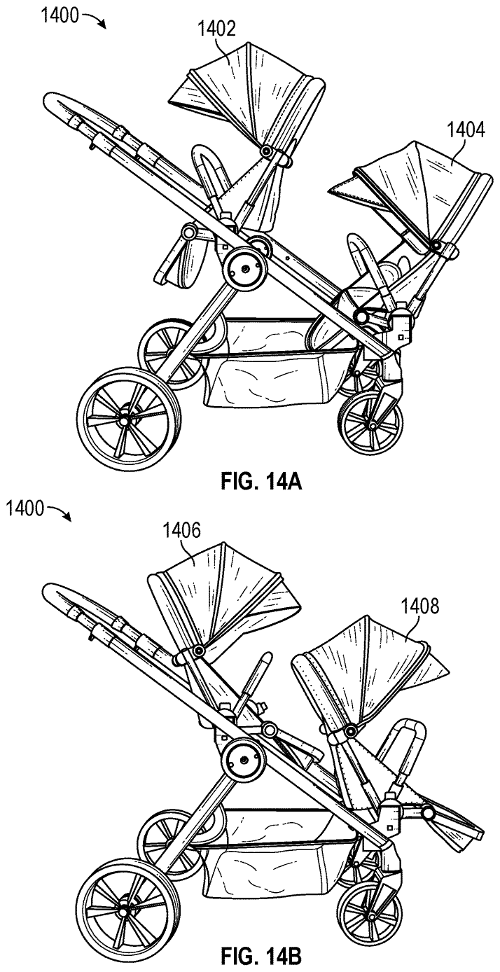

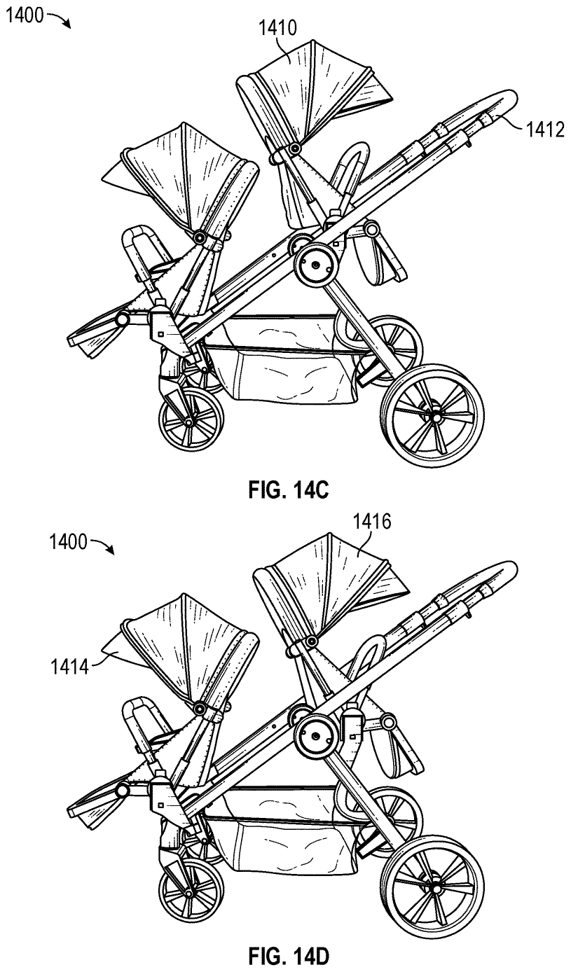

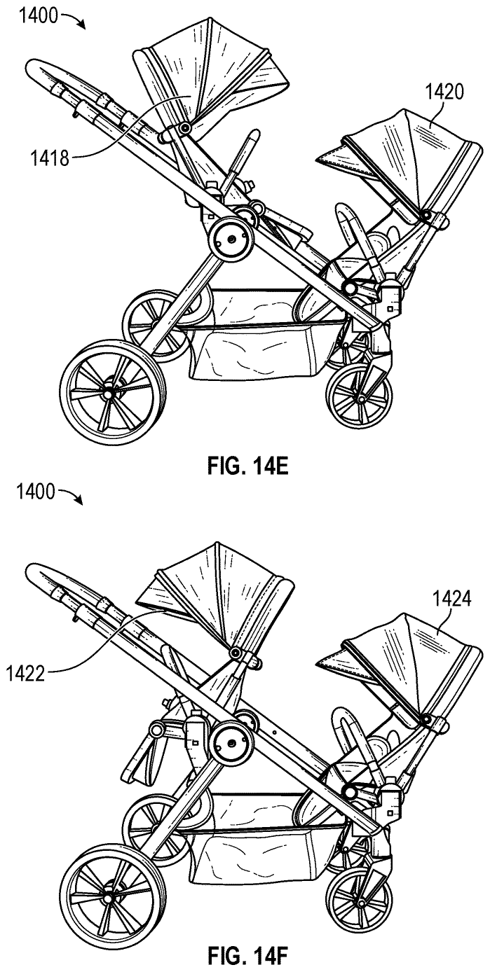

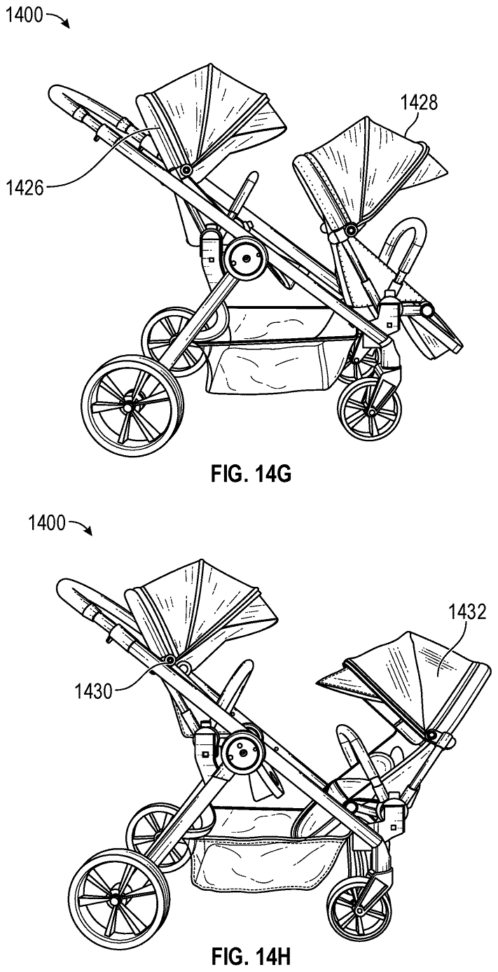

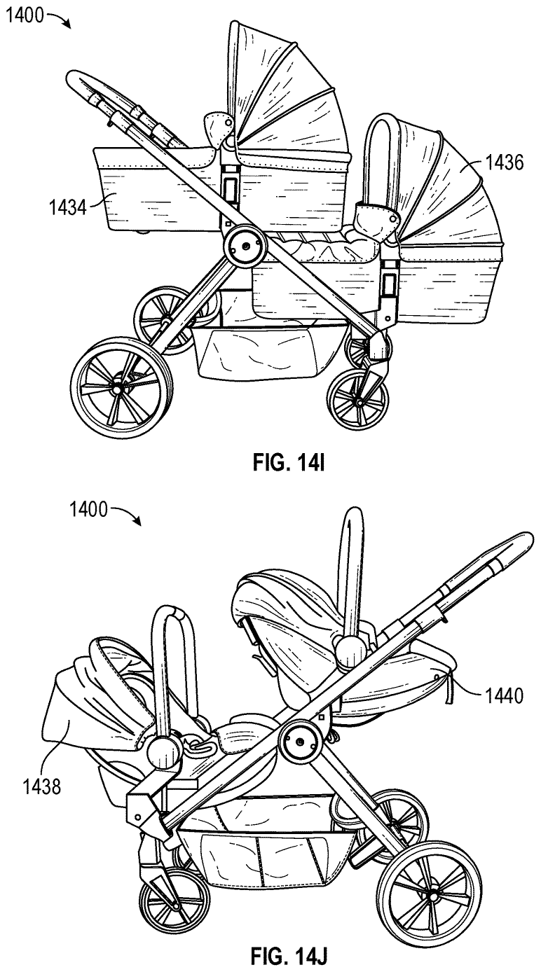

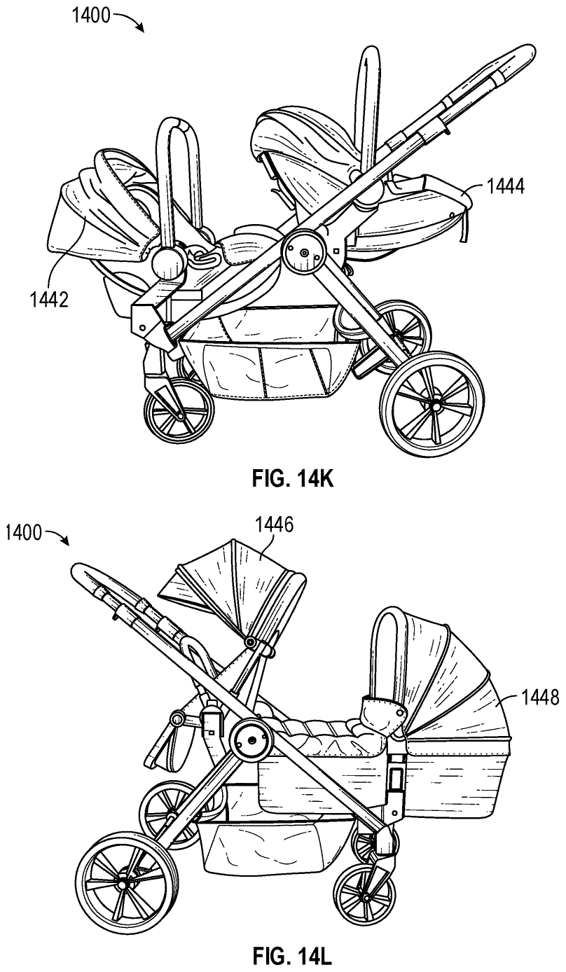

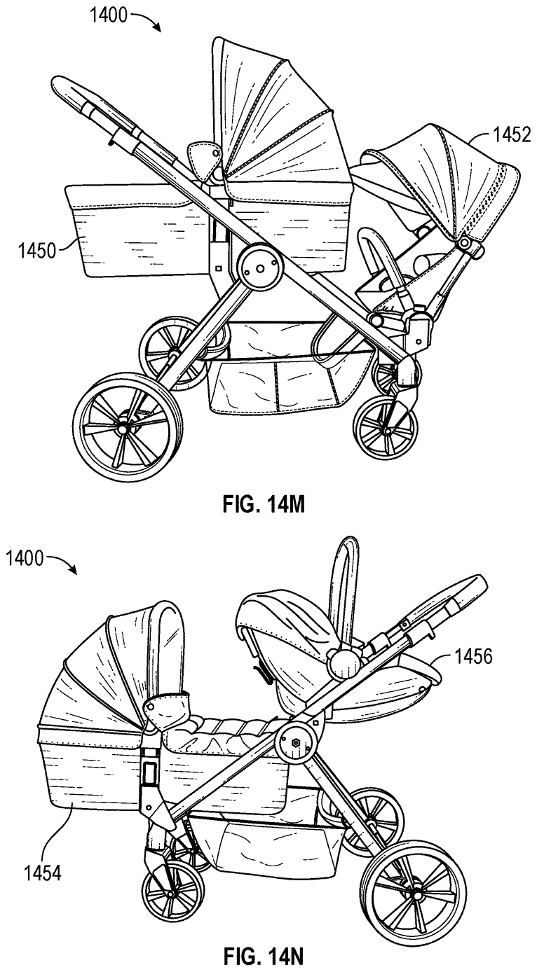

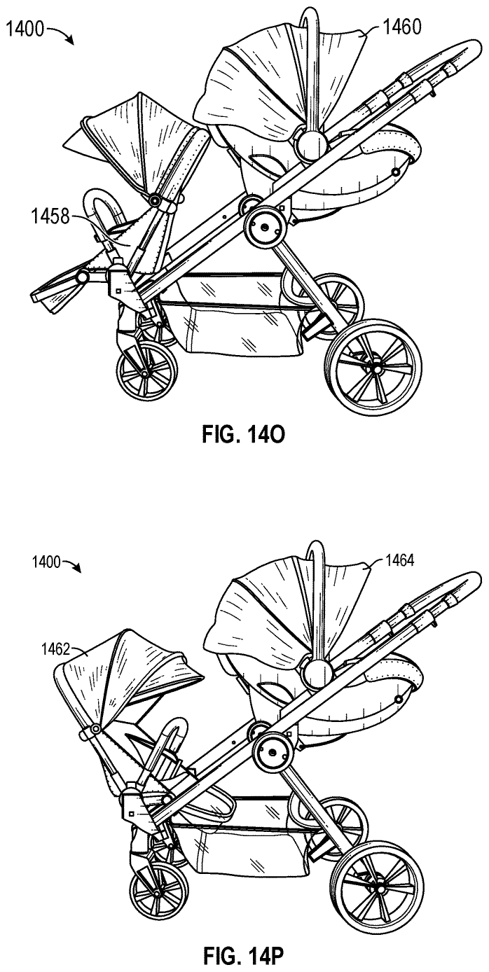

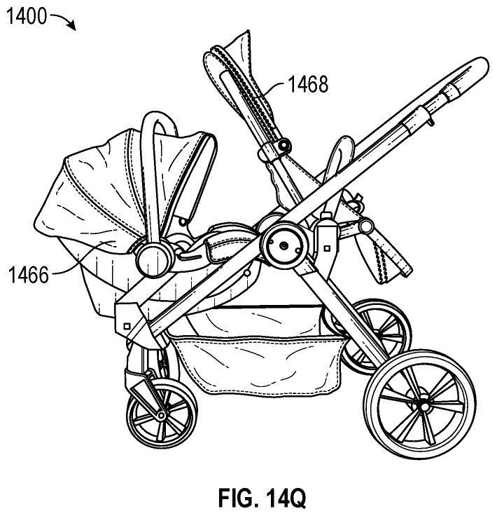

FIGS. 14A-14Q illustrate alternative staggered double seat arrangements on an adjustable stroller assembly 1400.

FIG. 14A shows a first seat 1402 and a second seat 1402 (which may both be a first type of seat) that are provided at different heights and in the same orientation. For example, the first seat 1402 and the second seat 1404 are both shown as facing a second orientation (e.g., rearward-facing). Thus, the first seat 1402 and the second seat 1404 are at different heights and facing each other. FIG. 14B shows a first seat 1406 and a second seat 1408 (which may both be the first type of seat) that are also provided at different heights and in the same orientation. However, the first seat 1406 and second seat 1408 both forward-facing instead of rearward-facing.

FIG. 14C shows a first seat 1410 and a second seat 1412 (which may both be a first type of seat) that are provided at different heights and in different orientations. For example, the first seat 1410 is shown as facing a first orientation (e.g., forward-facing) and the second seat 1412 is shown as facing a second orientation (e.g., rearward-facing). Thus, the first seat 1410 and the second seat 1412 are at different heights and facing away from each other. FIG. 14D also shows a first seat 1414 and a second seat 1416 that are at different heights and facing in opposite directions. However, the second seat 1416 in FIG. 14D is provided at a slightly lower height than the second seat 1412 in FIG. 14C.

FIG. 14E shows a first seat 1418 and a second seat 1420 (which may both be a first type of seat) that are provided at different heights and in different orientations. For example, the first seat 1418 is shown as facing a first orientation (e.g., forward-facing) and the second seat 1420 is shown as facing a second orientation (e.g., rearward-facing). Thus, the first seat 1418 and the second seat 1420 are at different heights and facing towards one another. FIG. 14F shows a first seat 1422 and a second seat 1424 that are at different heights and facing in the same direction.

FIG. 14G shows a first seat 1426 and a second seat 1428 (which may both be a first type of seat) that are provided at different heights and in the same orientation. For example, the first seat 1426 and the second seat 1428 are both shown as facing a first orientation (e.g., forward-facing). FIG. 14H shows a first seat 1430 and a second seat 1432 that are at different heights and facing in the same direction. The first seat 1430 and the second seat 1432 may also be the first type of seat.

FIG. 14I shows a first seat 1434 and a second seat 1436 (which may both be a second type of seat) that are provided at different heights and in the same orientation. For example, the first seat 1434 and the second seat 1436 are both shown as facing a second direction (e.g., rearward-facing). FIG. 14J also shows a first seat 1438 and a second seat 1440 that are at different heights and facing in the same direction. However, the first seat 1438 and the second seat 1440 are both facing the rearward-direction. The first seat 1430 and the second seat 1432 may also be a third type of seat.

FIG. 14K shows a first seat 1442 and a second seat 1444 (which may both be the third type of seat) that are provided at different heights and in the same orientation. For example, the first seat 1442 and the second seat 1444 are both shown as facing a second direction (e.g., rearward-facing). FIG. 14L also shows a first seat 1446 and a second seat 1448 that are at different heights and facing in the rearward-direction. The first seat 1446 may be the first type of seat and the second seat 1448 may be the second type of seat.

FIG. 14M shows a first seat 1450 (which may be the second type of seat) and a second seat 1452 (which may both be the first type of seat) that are provided at different heights and in the same orientation. For example, the first seat 1450 and the second seat 1452 are both shown as facing a second direction (e.g., rearward-facing). FIG. 14N also shows a first seat 1454 and a second seat 1456 that are at different heights and facing in the rearward-direction. The first seat 1454 may be the second type of seat and the second seat 1456 may be the third type of seat.

FIG. 140 shows a first seat 1458 (which may be the first type of seat) and a second seat 1460 (which may be the third type of seat) that are provided at different heights and in different orientations. For example, the first seat 1458 is shown as facing a first direction (e.g., forward-facing) and the second seat 1460 is shown as facing a second direction (e.g., rearward-facing). FIG. 14P also shows a first seat 1462 and a second seat 1464 that are at different heights and facing in the rearward-direction. The first seat 1462 may be the first type of seat and the second seat 1464 may be the third type of seat.

FIG. 14Q shows a first seat 1466 (which may be the third type of seat) and a second seat 1468 (which may be the first type of seat) that are provided at different heights and in the same orientation. For example, the first seat 1466 and the second seat 1468 are both shown as facing a second orientation (e.g., rearward-facing).

It should be noted that the configurations shown in FIGS. 12A-14R are merely exemplary and any other configurations of different types of seats at different heights and in different orientations may also be used. Additionally, any other combination of different types of seats in any these configurations may also be used, including seat types not shown herein.

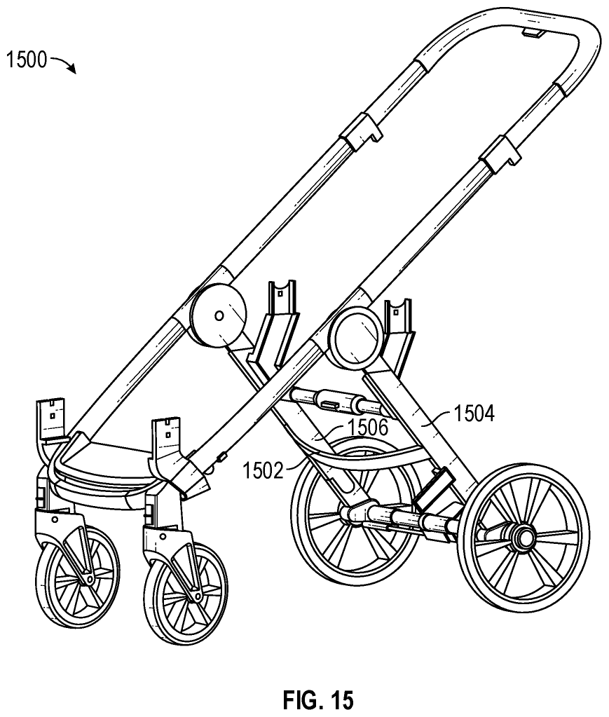

FIG. 15 illustrates an alternative adjustable stroller assembly 1500. The alternative adjustable stroller assembly 1500 is similar to other adjustable stroller assemblies described herein, but also includes an additional crossbar 1502 between a first rear leg 1504 and a second rear leg 1506. The crossbar 1502 provides additional stability to the adjustable stroller assembly 1500. The crossbar 1502 may also be provided at any other location on the adjustable stroller assembly 1500 (or any other stroller assembly described herein) as well. The adjustable stroller assembly 1500 may also be provided without the crossbar 1502.

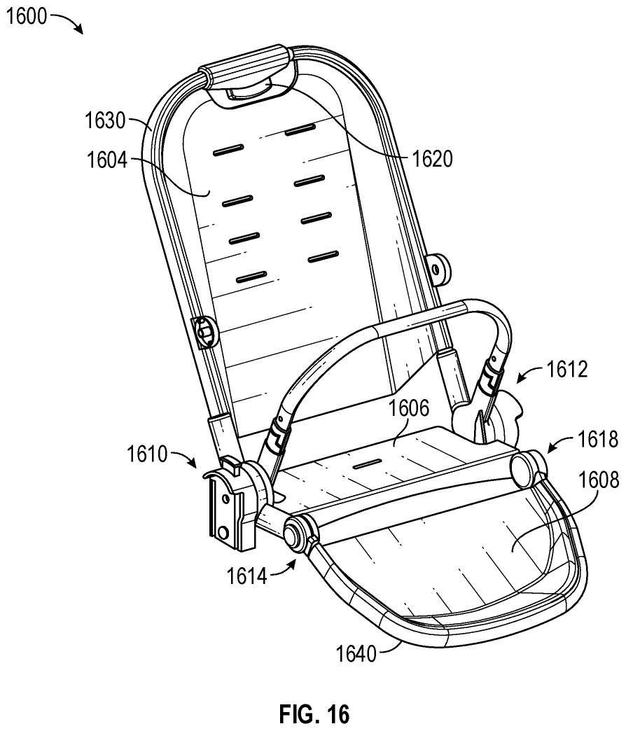

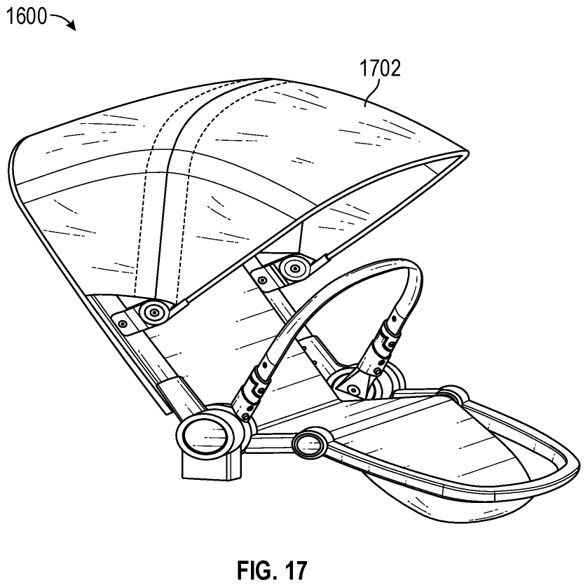

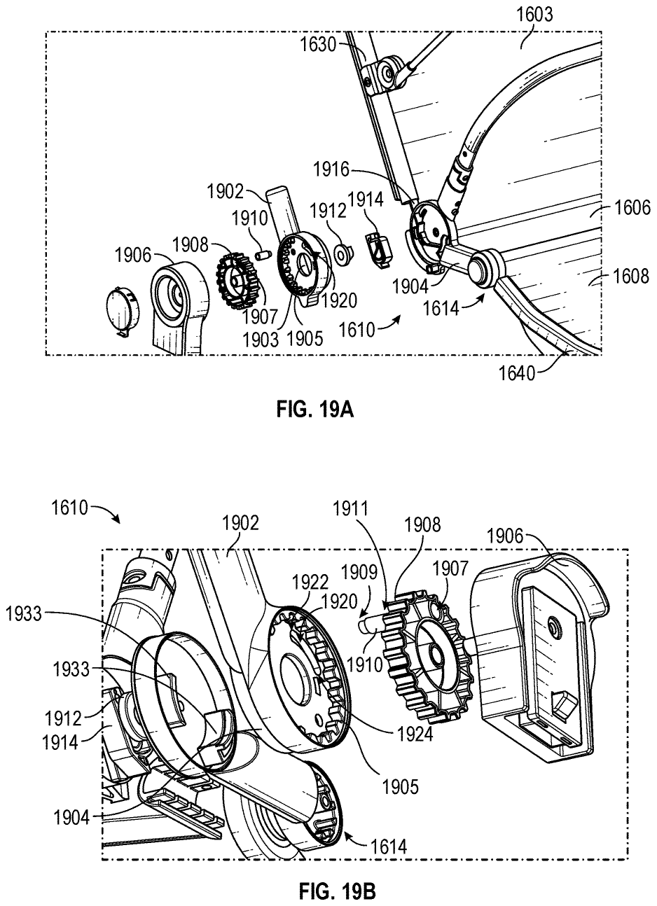

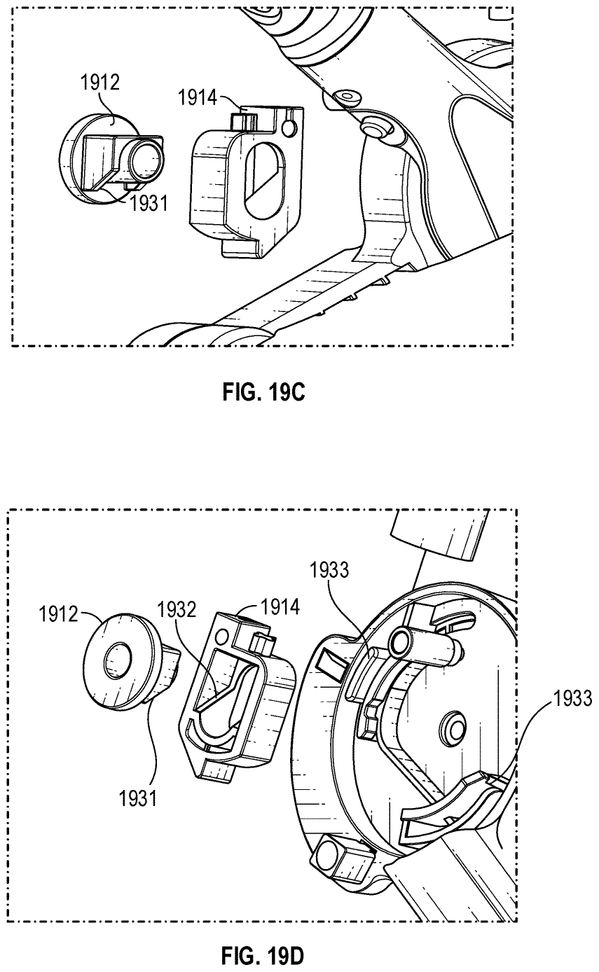

FIG. 16 illustrates an alternative seat 1600. The alternative seat 1600 is configured to be easily folded and rotated about the stroller frame for compact storage and/or transportation of the seat 1600 and/or a stroller to which the seat 1600 is mounted. FIG. 17 illustrates the seat 1600 of FIG. 16 including a canopy 1702. The seat 1600 includes a number of features, such as: (1) a recline hard stop mechanism (shown in FIGS. 19A-19D) of the seat 1600 disengages when the seat 1600 is folded, allowing the seat to be rotated about the stroller assembly when the seat 1600 is folded, (2) the seat 1600 folds by sliding the calf rest 1608 up, and (3) the seat 1600 folds by rotating about the recline hubs (for example, hubs 1610 and 1612) without having to use an actuator.

Some conventional seats for a stroller assembly have limited recline angles. This is to ensure the seat cannot be used in an unsafe manner. For example, the seat and rear portion could be rotated past horizontal if the recline limits were not in place. However, when the stroller assembly is folded, the seat typically protrudes at an angle from the stroller assembly due to the limited recline mechanism.

The seat 1600 described herein allow for the use of retractable recline limits when the seat 1600 is folded to create a compact fold. When the seat 1600 in an unfolded position for use (for example, unfolded such that a child may sit in the seat 1600) the rotation of the rear portion 1604 may be limited to a certain range. For example, the rear portion 1604 may be limited to 85 degrees up relative to the ground.

Given that this seat 1600 utilizes a two-piece seat design style, the seat mounting position may be lowered. Instead of having the seat mount on the top hoop, the seat mount may instead be located it near the seat bight. This helps with keeping the seat lower on the frame and decreasing the overall height and size the seat mounts on the stroller frame. Lower seats improve stability and shorter seat mounts increase strength.

The alternative seat 1600 includes a rear portion 1604, a seat portion 1606, and a calf rest 1608. A pair of laterally-opposed hubs (for example first hub 1610 and second hub 1612) are provided a connection point between the rear portion 1604 and the seat portion 1606. A second pair of laterally-opposed hubs (for example, third hub 1614 and fourth hub 1618) are provided at a connection point between the seat portion 1606 and the calf rest 1608. The hubs include mechanisms that control the manipulation of the seat 1600 (for example, the rotation of the seat 1600 relative to a stroller assembly, the rotation of the seat portion 1606 relative to the rear portion 1604, the rotation of the calf rest 1608 relative to the seat portion 1606, etc.). In this manner, the hubs allow the seat 1600 to be changed from an unfolded to folded configuration to provide for easier transportation and/or storage of the seat 1600.

In embodiments, the seat 1600 includes a rear frame 1630 that is provided around the rear portion 1604 and includes an internal channel (which may be a hollow interior of the rear frame 1630). The seat also includes a calf rest frame 1640 that is provided around the calf rest 1608. The channel may house one or more cables that may be operatively coupled to one or more mechanisms within the first hub 1610 and second hub 1612. A button 1620 may be provided on the rear portion 1604 that is used to control the movement of the one or more cables within the channel. If the recline button is depressed, the seat 1600 can then be rotated to its most reclined position. For example, this may be 40 degrees up from the ground. The recline limits keep the seat 1600 from being in an in-use condition outside of safe seat back angles. When the seat 1600 is open and in an in-use position we need to limit its rotation. When the seat is folded, the seat 1600 may rotate further both forward and backwards when compared to the recline rotation. This is because to achieve a compact fold with two seats mounted to the frame, there are instances where one may fold forward, and one may fold backward.

As is described in additional detail with respect to FIGS. 19A-19D, a user may press the button 1620 to cause the one or more cables to retract (increasing the tension in the cables) by a particular distance up into the channel. This movement of the one or more cables up into the channel causes the mechanism to which the one or more cables are operatively coupled to move upwards, which results in a change in the mechanism that allows for a rotation of the seat 1600 (the specific mechanism and the change that is caused is illustrated in FIGS. 19A-19D). The use of the single button 1620 provides an increased usability due to the simplicity of the design (the seat 1600 can be folded without the use of a secondary button).

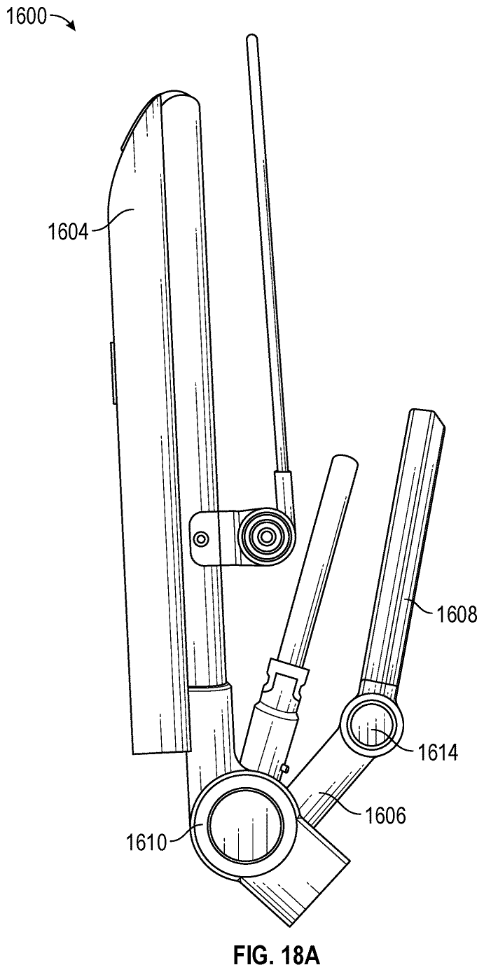

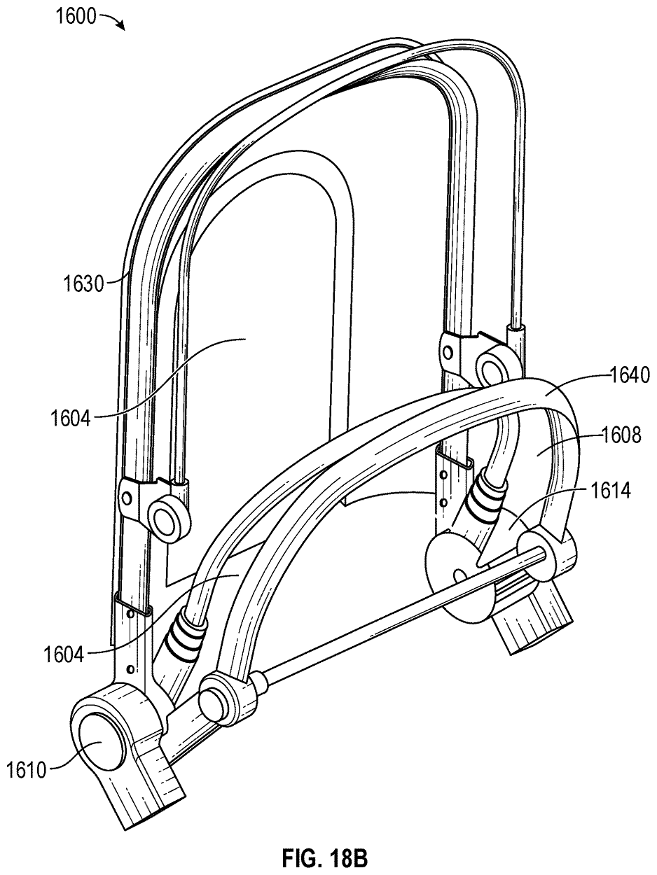

FIG. 18A illustrates a side view of the seat 1600 of FIG. 16 in a folded configuration. FIG. 18B illustrates a perspective view of the seat 1600 of FIG. 16 in a folded configuration.

FIGS. 19A-19D illustrate components of a hub (for example, hub 1610) of the seat 1600 of FIG. 16. The components included within the hub 1610 may be configured to allow for rotation of the rear portion 1604 of the seat 1600 relative to the seat portion 1606 of the seat 1600 (for example, reclining the rear portion 1604).

Beginning with FIG. 19A, an exploded view of the components included in the hub 1610 is shown. The hub 1610 may include a housing 1906 which may house at least a first seat frame joint 1902 and a second seat frame joint 1904. The housing 1906 may be removably coupled to a frame of the adjustable stroller (which may be any stroller described herein), such as front seat frame 302 (as a non-limiting example), such that the seat 1600 may be provided on the adjustable stroller. The first seat frame joint 1902 may be operatively coupled to the rear frame 1630 of the seat 1600 such that rotation of the rear portion 1604 of the seat 1600 causes a rotation of the first seat frame joint 1902 relative to the hub 1610. The second seat frame joint 1904 may be operatively coupled to the calf rest frame 1640 of the seat 1600 such that rotation of the seat portion 1606 causes a rotation of the second seat frame joint 1904 relative to the hub 1610.

Within the hub 1610, a reclining gear 1908 may be provided that is configured to provide limited rotation of the seat 1600 while in an unfolded configuration. That is, the reclining gear 1908 is a mechanism that regulates the rotation of the first seat frame joint 1902 relative to adjustable stroller. The reclining gear 1908 is normally housed within both the first seat frame joint 1902 and the housing 1906. The first seat frame joint 1902 and the housing 1906 each include a set of teeth (for example, teeth 1905 inside first seat frame joint 1902 are shown in FIGS. 19A-19B). The teeth engage with the teeth on the reclining gear 1908 to prevent rotation of the first seat frame joint 1902 and the seat 1600 relative to the housing 1906.

To provide for a mechanism by which limited rotation of the seat 1600 may be performed, a pin 1910 is provided. A distal end 1911 of the pin 1910 is provided with an aperture 1907 of the reclining gear 1908 and a proximal end 1909 of the pin 1910 is provided within a slot 1920 within the first seat frame joint 1902. When the reclining gear 1908 is pushed out of the first seat frame joint 1902 and into the housing 1906, the first seat frame joint 1902 is able to rotate in a limited capacity relative to the housing 1906, with the rotation being limited by the moment of the pin 1910 within the slot 1910 between a first end 1922 or a second end 1924.

In embodiments, the reclining gear 1908 may be pushed into the housing 1906 to allow for this limited rotation using a button 1620. The button 1620 is operatively connected to the cable 1916 within the channel of the rear frame 1630. When the button 1620 is pushed (or pulled) by a user, the cable 1916 may be pulled upwards within the channel, consequentially raising the ramp element 1914 within the hub 1610. As shown in FIG. 19C, the gear connector 1912 includes a first ramped portion 1931 and the ramp element 1914 includes a corresponding second ramped portion 1932. When the components are assembled within the hub 1610, and the gear connector 1612 and the ramp element 1914 are in contact, the first ramped portion 1931 and the second ramped portion 1932 are in contact. When the button 1620 is pressed (or pulled) by a user and the ramp element 1914 is pulled upwards by the cable 1916, the ramped portion 1932 slides relative to the ramped portion 1931. This causes the gear connector 1912 to move outwards in a direction away from the ramp element 1914. The movement of the gear connector 1912 consequentially pushes the reclining gear 1908 out of the first seat frame joint 1902 and fully within the housing 1906.

When the button 1620 is released, the pulling force of the cable 1916 is removed and the ramp element 1914 is returned back to its original position. The gear connector 1912 is returned back to its original location in closer proximity to the ramp element 1914, and the reclining gear 1908 returns to its original position within both the housing 1906 and the first seat frame joint 1902, thus re-introducing the rotational limitation of the reclining gear 1908.

The seat 1600 may also be configured to perform unlimited rotation when the seat 1600 is in a folded configuration. This may be beneficial, for example, if the seat 1600 is provided on a stroller assembly and it is desired to fold the stroller assembly. As aforementioned, the reclining gear 1908 may be operative connected to the gear connector 1912 through an aperture 1903 in the first seat frame joint 1902. The gear connector 1912 may also be connected to a ramp element 1914, which is connected to the second seat frame joint 1904. The ramp element 1914 is also connected to a cable 1916 that is provided within a channel of the rear frame 1630.

To eliminate the rotational limitation resulting from the pin 1910 being provided within the slot 1920 of the first seat frame joint 1902, one or more protrusions 1933 may be provided on the second seat frame joint 1904. When the seat portion 1606 and/or calf rest 1608 are rotated to the folded position, at least one of the one or more protrusions 1933 may also be rotated to the location of the slot 1920. The protrusion may also protrude into the slot 1920, which may similarly cause the pin 1910 to be pushed away from the slot 1920.

Similarly, at least one of the one or more protrusions 1933 may also engage with a protrusion 1934 on the ramp element 1914. This engagement causes the ramp element 1914 to be pushed upwards in a similar manner in which the ramp element 1914 is pulled upwards by the cable 1916. Thus, rotating the seat portion 1606 and/or the calf rest 1608 upwards to produce the folded configuration of the seat 1600 both causes the pin 1910 to be pushed outwards from the slot 1920 and causes the reclining gear 1908 to be pushed out of the first seat frame joint 1902 and into the housing 1906. Both of these actions eliminate the rotation limitations on the seat 1600 imposed by the combination of the reclining gear 1908 and the pin 1910.

Once the pin 1910 is pushed away from the slot 1920, the seat 1600 may then be rotated about the hubs 1610 and 1614 without limitation. For example, if the seat 1600 is provided on a stroller assembly, the seat 1600 may be rotated about the stroller assembly (without the user needing to press the button 1620) once the seat 1600 is folded. When the seat 1600 is unfolded, the protrusion 1932 disengages from the slot 1920 and the pin 1920 returns to the slot 1920.

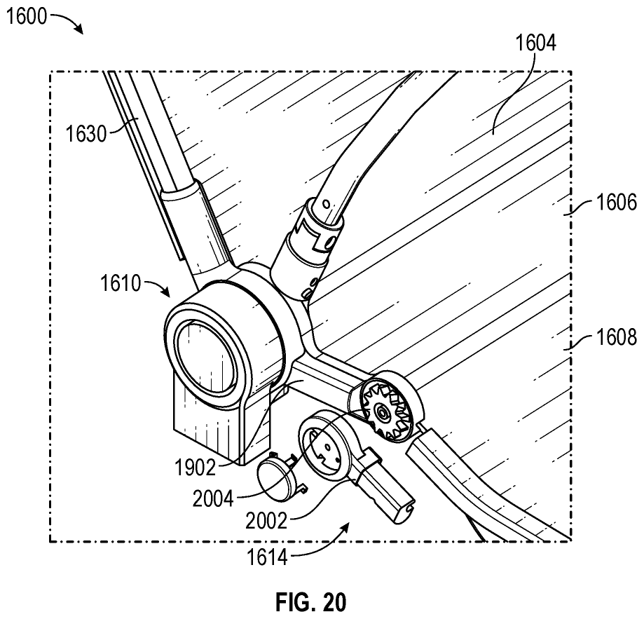

FIG. 20 illustrates components of another hub 1614 of the seat 1600 of FIG. 16 (for example, the hub that controls rotation of the calf rest 1608 relative to the seat portion 1606). The hub 1614 may serve as a connection joint between the first seat frame joint 1902 and a first calf rest joint 2002. The first calf rest joint 2002 may be configured to rotate relative to the first seat frame joint 1902 using a gear 2004 provided within the hub 1614. This rotational capability allows the calf rest 1608 to be rotated relative to the seat portion 1606 (the lower seat frame 1640 relative to the first seat frame joint 1902). For example, a user may grasp the low frame 1640 of the seat 1604 to rotate the calf rest 1608 about the hub 1614.

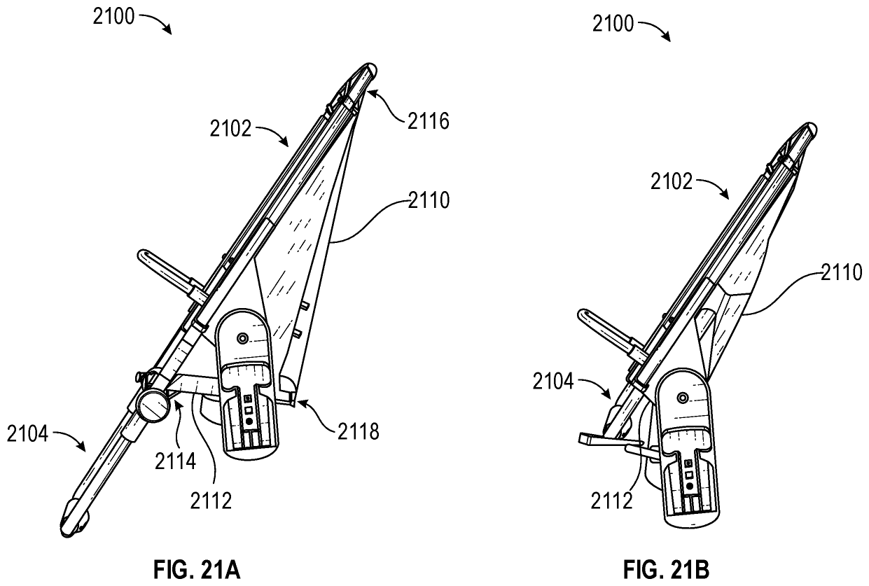

FIGS. 21A-21B illustrates an alternative seat 2100. The seat 2100 is an alternative seat configuration that is able to fold in a different manner than the seat 1600 illustrated in FIG. 16. That is, the seat 2100 is able to be folded into a compact configuration by using a slidable seat frame. FIG. 21A shows the seat 2100 in an unfolded configuration and FIG. 2AB shows the seat 2100 in a folded configuration.

In embodiments, the seat 2100 includes a top frame 2102 and a bottom frame 2104. The bottom frame 2104 is configured to be slidable relative to the top frame 2102 such that the bottom frame 2104 may be slid upwards towards the top frame 2102. As the bottom frame 2014 is slid up along the top frame, the seat 2100 reduces in size. is the seat 2100 is able to fold in on itself given the dimensions of the seat back 2110, seat bottom 2112, and slide length. When the seat 2100 is open in an in-use position (as shown in FIG. 21A), the frame (including the top frame 2102 and the bottom frame 2104), seat bottom 2112, and seat back 2110 create a triangular shape.

Each of the ends of the seat back 2110 and seat bottom 2112 are attached to the frame and can rotate. For example, the seat bottom 2112 may be attached to the bottom frame 2104 at connection point 2114 and seat back 2110 may be attached to the top frame 2102 at connection point 2116. Thus, when a user pushes the bottom frame 2104 upwards towards the top frame 2102, the seat bottom 2112 is also pulled upwards along with the bottom frame 2104 at the connection point 2114. That is, the seat bottom 2112 rotates up about the axis where the seat bottom 2112 and seat back 2110 are attached. As the seat bottom 2112 is lifted and rotated, the seat bottom 2112 pulls the seat back 2100 closer to the sliding frame of the seat 2100 (given that the seat bottom 2112 and seat back 2110 are connected at connection point 2118. Once the bottom frame 2104 is slid to a maximum sliding distance, the seat back 2100 will then be substantially parallel with the sliding frame of the seat 2100, resulting in the folded configuration shown in FIG. 21B. To achieve the folded configuration shown in FIG. 21B, the seat bottom 2112 may be the same length as the distance the seat frame slides.

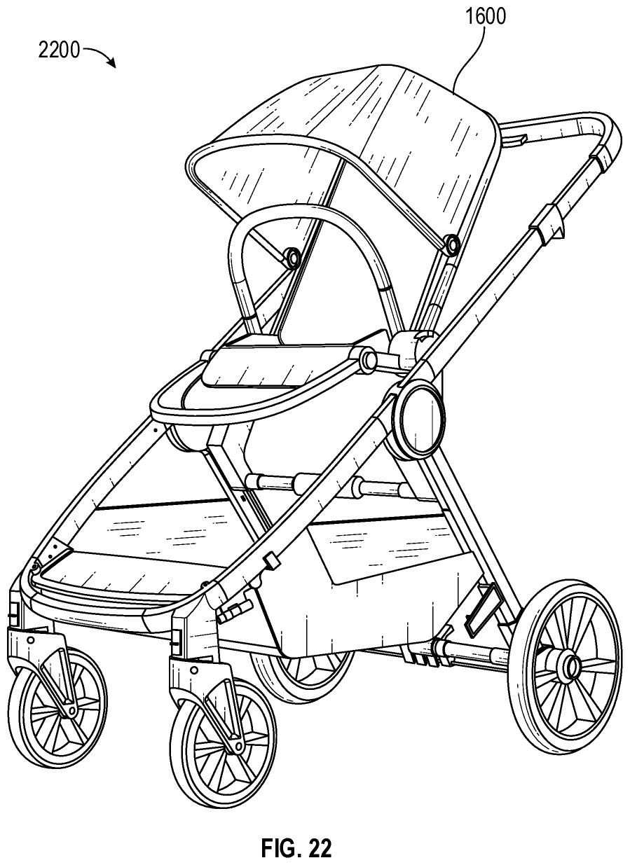

FIG. 22 illustrates an adjustable stroller assembly including the seat 1600 of FIG. 16 in accordance with the principles of the present disclosure.

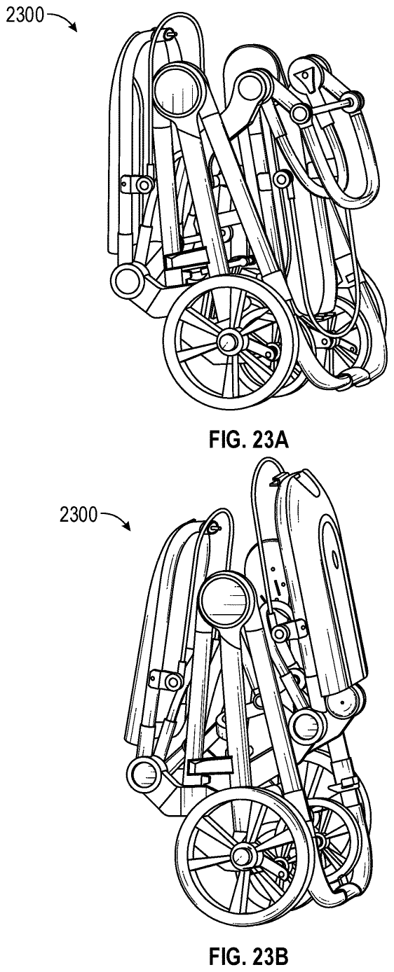

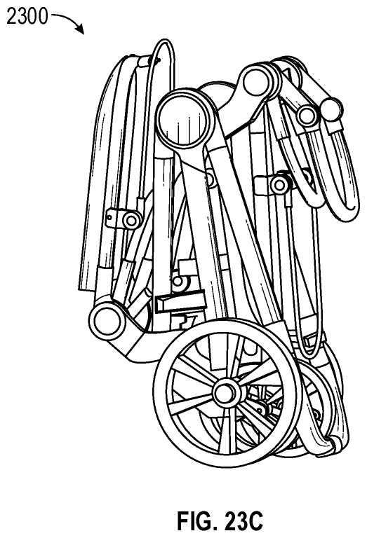

FIGS. 23A-23C illustrate an adjustable stroller assembly 2300 in a folded configuration in accordance with the principles of the present disclosure.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

Embodiment 1 may include an adjustable stroller assembly comprising: a stroller frame comprising a pair of laterally opposed connection points; a plurality of wheels coupled to the stroller frame; a first seat frame adjustably coupled to the stroller frame, the first seat frame configured to be adjusted relative to the pair of laterally opposed connection points between a first position and a second position that is relatively higher than the first position; and a second seat frame configured to be removably coupled to the stroller frame.

Embodiment 2 may include Embodiment 1, wherein the stroller frame comprises a rear frame assembly coupled to the pair of laterally opposed connection points.

Embodiment 3 may include any of Embodiments 1 to 2, wherein the first seat frame is slidably coupled to the rear frame assembly, such that the first seat frame is configured to slide along the rear frame assembly between the first position and the second position.

Embodiment 4 may include any of Embodiments 1 to 3, wherein the first seat frame comprising one or more actuators, the one or more actuators configured to be actuated to permit sliding of the first seat frame between the first position and the second position.

Embodiment 5 may include any of Embodiments 1 to 4, wherein the rear frame assembly comprises: a pair of opposed rear bars extending from the pair of laterally opposed connection points, each rear bar of the pair of opposed rear bars defining a respective channel, wherein the first seat frame is slidably secured between and within the respective channels of the pair of opposed rear bars.

Embodiment 6 may include any of Embodiments 1 to 5, wherein the stroller frame comprises a front frame assembly coupled to the pair of laterally opposed connection points.

Embodiment 7 may include any of Embodiments 1 to 6, wherein the front frame assembly comprises a seat frame mount, and wherein the second seat frame is removably coupled to the seat frame mount.

Embodiment 8 may include any of Embodiments 1 to 7, wherein the stroller frame comprises an upper frame assembly coupled to the pair of laterally opposed connection points.

Embodiment 9 may include any of Embodiments 1 to 8, wherein the upper frame assembly comprises: a pair of opposed upper bars extending from the pair of laterally opposed connection points; and a handle coupled between the pair of opposed upper bars.

Embodiment 10 may include any of Embodiments 1 to 9, wherein the plurality of wheels comprise at least two rear wheels and at least two front wheels.

Embodiment 11 may include any of Embodiments 1 to 10, wherein the pair of laterally opposed connection points are offset from a geometric center between the at least two rear wheels and at least two front wheels in a direction toward the at least two rear wheels.

Embodiment 12 may include any of Embodiments 1 to 11, wherein, when the first seat frame is in the first position and the second seat frame is coupled to the stroller frame, the first seat frame and the second seat frame are in a same plane.

Embodiment 13 may include any of Embodiments 1 to 12, wherein, when the second seat frame is coupled to the stroller frame, the first seat frame and the second seat frame face each other.

Embodiment 14 may include any of Embodiments 1 to 13, wherein at least one of the first seat frame or the second seat frame is configured to support a stroller seat.

Embodiment 15 may include any of Embodiments 1 to 14, wherein at least one of the first seat frame or the second seat frame is configured to support a carrycot.

Embodiment 16 may include any of Embodiments 1 to 15, wherein at least one of the first seat frame or the second seat frame is configured to support a car seat.

Embodiment 17 may include any of Embodiments 1 to 16, further comprising at least one finishing material coupled to at least a portion of the adjustable stroller assembly.

Embodiment 18 may include any of Embodiments 1 to 17, wherein the at least one finishing material comprises at least one of a liner, a foam, a netting, a web, a fabric, or a padding.

Embodiment 19 may include any of Embodiments 1 to 18, wherein the first seat frame is rotatably coupled to the pair of laterally opposed connection points, such that the first seat frame is configured to rotate about the pair of laterally opposed connection points between the first position and the second position.

Embodiment 20 may include any of Embodiments 1 to 19, wherein the first seat frame comprising one or more actuators, the one or more actuators configured to be actuated to permit rotation of the first seat frame between the first position and the second position.

Embodiment 21 may include an adjustable stroller assembly comprising: a stroller frame comprising a pair of laterally opposed connection points; a rear seat frame configured to be slidably moveable along the stroller frame relative to the pair of laterally opposed connection points; and a front seat frame configured to be removably coupled to the stroller frame, wherein the stroller frame is configured to be actuated to slidably move the rear seat frame between a first position and a second position that is relatively higher than the first position.

Embodiment 22 may include an adjustable stroller assembly comprising: a stroller frame comprising: a pair of laterally opposed connection points; a pair of rear legs extending downwardly from the pair of laterally opposed connection points in a rearward direction; and a pair of front legs extending downwardly from the pair of laterally opposed connection points in a forward direction; a rear seat frame adjustably coupled to the pair of rear legs, the rear seat frame configured to be adjusted relative to the pair of laterally opposed connection points between a first position and a second position that is relatively higher than the first position; and a front seat frame configured to be removably coupled to the pair of front legs.

Embodiment 23 may include an adjustable stroller assembly comprising: a stroller frame comprising: a pair of laterally opposed connection points; a pair of rear legs extending downwardly from the pair of laterally opposed connection points in a rearward direction; a pair of upper bars extending upwardly from the pair of laterally opposed connection points in a rearward direction; a pair of rear support bars extending between the pair of rear legs and the pair of upper bars; and a pair of front legs extending downwardly from the pair of laterally opposed connection points in a forward direction; a rear seat frame adjustably coupled to the pair of rear support bars, the rear seat frame configured to be adjusted relative to the pair of laterally opposed connection points between a first position and a second position that is relatively higher than the first position; and a front seat frame configured to be removably coupled to the pair of front legs.

Embodiment 24 may include A seat for a stroller assembly comprising: a rear portion; a seat portion that is rotatably connected to the seat portion at a first hub and a second hub that is laterally opposed to the first hub; and a calf rest that is rotatably connected to the seat portion at a third hub and a fourth hub that is laterally opposed to the first hub, wherein the seat portion and calf rest are configured to rotate towards the rear portion into a folded configuration.

Embodiment 25 may include Embodiment 24, wherein the first hub further comprises a first seat frame joint that is configured to receive a rear frame of the rear portion, and a second seat frame joint that is rotatably connected to the first seat frame joint and configured to receive a calf rest frame of the calf rest.

Embodiment 26 may include any of Embodiments 24 to 25, wherein the first seat frame joint is configured to receive a gear to control the rotation of the rear portion about the first hub and second hub, wherein the gear includes a pin provided within an aperture of the gear, wherein the first seat frame joint further includes a slot configured to receive the pin, wherein the slot limits a movement of the pin and the rotation of the gear.

Embodiment 27 may include any of Embodiments 24 to 26, wherein the second seat frame joint further comprises a first protrusion that removably inserts into the slot and pushes the pin outwards from the slot when the seat is in the folded configuration.

Embodiment 28 may include any of Embodiments 24 to 27, wherein the seat is configured to rotate about the first hub and the second hub in an unlimited manner with the pin being pushed outwards from the slot.

Embodiment 29 may include any of Embodiments 24 to 28, wherein the first hub further comprises a gear connector that is operatively coupled to the gear, wherein the gear connector further comprises a first ramped portion that is slidably engaged with a second ramped portion of a ramp element.

Embodiment 30 may include any of Embodiments 24 to 29, wherein the first hub further comprises a gear connector that is operatively coupled to the gear, wherein the gear connector further comprises a first ramped portion that is slidably engaged with a second ramped portion of a ramp element.

Embodiment 31 may include any of Embodiments 24 to 30, wherein the second seat frame joint further comprises a second protrusion that engages with a protrusion on a ramp element when the seat is in the folded configuration, wherein the engagement causes the gear to be pushed outwards from the first seat frame joint.

Embodiment 32 may include any of Embodiments 23 to 31, further comprising a button operatively connected to a cable included within a frame of the seat and connected to the ramp element, wherein pressing the button causes a tension in the cable that pulls the ramp element from the first position to the second position.

Embodiment 33 may include any of Embodiments 24 to 32, wherein the third hub further comprises the second seat frame joint, a third seat frame joint that is rotatably coupled to the second seat frame joint, and a gear to control the rotation of the calf rest.

Embodiment 34 may include A seat for a stroller assembly comprising: a seat back including a first end of the seat back that is connected to a top frame; and a seat bottom including a first end of the seat bottom that is connected to a second end of the seat back and a second end of the seat bottom that is connected to a bottom frame, wherein the bottom frame is configured to slide relative to the top frame, wherein sliding the bottom frame upwards towards the top frame pulls the second end of the seat bottom upwards and pulls the first end of the seat bottom and the second end of the seat back towards the top frame and bottom frame into a folded configuration.

1. An adjustable stroller assembly comprising:
a stroller frame comprising a pair of laterally opposed connection points;
a plurality of wheels coupled to the stroller frame;
a first seat frame adjustably coupled to the stroller frame, the first seat frame configured to be adjusted relative to the pair of laterally opposed connection points between a first position and a second position that is relatively higher than the first position; and
a second seat frame configured to be removably coupled to the stroller frame.

2. The adjustable stroller assembly of claim 1, wherein the stroller frame comprises a rear frame assembly coupled to the pair of laterally opposed connection points.

3. The adjustable stroller assembly of claim 2, wherein the first seat frame is slidably coupled to the rear frame assembly, such that the first seat frame is configured to slide along the rear frame assembly between the first position and the second position.

4. The adjustable stroller assembly of claim 3, wherein the first seat frame comprising one or more actuators, the one or more actuators configured to be actuated to permit sliding of the first seat frame between the first position and the second position.

5. The adjustable stroller assembly of claim 3, wherein the rear frame assembly comprises:
a pair of opposed rear bars extending from the pair of laterally opposed connection points, each rear bar of the pair of opposed rear bars defining a respective channel,
wherein the first seat frame is slidably secured between and within the respective channels of the pair of opposed rear bars.

6. The adjustable stroller assembly of claim 1, wherein the stroller frame comprises a front frame assembly coupled to the pair of laterally opposed connection points.

7. The adjustable stroller assembly of claim 6, wherein the front frame assembly comprises a seat frame mount, and wherein the second seat frame is removably coupled to the seat frame mount.

8. The adjustable stroller assembly of claim 1, wherein the stroller frame comprises an upper frame assembly coupled to the pair of laterally opposed connection points.

9. The adjustable stroller assembly of claim 8, wherein the upper frame assembly comprises:
a pair of opposed upper bars extending from the pair of laterally opposed connection points; and
a handle coupled between the pair of opposed upper bars.

10. The adjustable stroller assembly of claim 1, wherein the plurality of wheels comprise at least two rear wheels and at least two front wheels.

11. The adjustable stroller assembly of claim 10, wherein the pair of laterally opposed connection points are offset from a geometric center between the at least two rear wheels and at least two front wheels in a direction toward the at least two rear wheels.

12. The adjustable stroller assembly of claim 1, wherein, when the first seat frame is in the first position and the second seat frame is coupled to the stroller frame, the first seat frame and the second seat frame are in a same plane.

13. The adjustable stroller assembly of claim 1, wherein, when the second seat frame is coupled to the stroller frame, the first seat frame and the second seat frame face each other.

14. The adjustable stroller assembly of claim 1, wherein at least one of the first seat frame or the second seat frame is configured to support a stroller seat.

15. The adjustable stroller assembly of claim 1, wherein at least one of the first seat frame or the second seat frame is configured to support a carrycot.

16. The adjustable stroller assembly of claim 1, wherein at least one of the first seat frame or the second seat frame is configured to support a car seat.

17-18. (canceled)

19. The adjustable stroller assembly of claim 1, wherein the first seat frame is rotatably coupled to the pair of laterally opposed connection points, such that the first seat frame is configured to rotate about the pair of laterally opposed connection points between the first position and the second position.

20. The adjustable stroller assembly of claim 19, wherein the first seat frame comprising one or more actuators, the one or more actuators configured to be actuated to permit rotation of the first seat frame between the first position and the second position.

21. An adjustable stroller assembly comprising:
a stroller frame comprising a pair of laterally opposed connection points;
a rear seat frame configured to be slidably moveable along the stroller frame relative to the pair of laterally opposed connection points; and
a front seat frame configured to be removably coupled to the stroller frame,
wherein the stroller frame is configured to be actuated to slidably move the rear seat frame between a first position and a second position that is relatively higher than the first position.

22. (canceled)

23. An adjustable stroller assembly comprising:
a stroller frame comprising:
a pair of laterally opposed connection points;
a pair of rear legs extending downwardly from the pair of laterally opposed connection points in a rearward direction;
a pair of upper bars extending upwardly from the pair of laterally opposed connection points in a rearward direction;
a pair of rear support bars extending between the pair of rear legs and the pair of upper bars; and
a pair of front legs extending downwardly from the pair of laterally opposed connection points in a forward direction;
a rear seat frame adjustably coupled to the pair of rear support bars, the rear seat frame configured to be adjusted relative to the pair of laterally opposed connection points between a first position and a second position that is relatively higher than the first position; and
a front seat frame configured to be removably coupled to the pair of front legs.

24-34. (canceled)
